(19) United States
(12) Patent Application Publication
(10) Pub. No.: US 2025/0250173 A1
(43) Pub. Date: Aug. 7, 2025

(54) Upcycling Plastic Wastes into Graphites, Graphenes and Graphitic Carbons, for Electrochemical Energy Storage Devices

(71) Applicant: Battelle Memorial Institute, Columbus, OH (US)

(72) Inventors: Ki-Joong Kim, Pittsburgh, PA (US); Viet Hung Pham, Pittsburgh, PA (US); Yuan Gao, Pittsburgh, PA (US); Congjun Wang, Bethel Park, PA (US); Christopher Matranga, Pittsburgh, PA (US); Huynh Ngoc Tien, Bethel Park, PA (US)

(21) Appl. No.: 19/046,368

(22) Filed: Feb. 5, 2025

Related U.S. Application Data
(60) Provisional application No. 63/549,827, filed on Feb. 5, 2024.
(60) Provisional application No. 63/575,682, filed on Apr. 6, 2024.

(51) Int. Cl. C01B 32/205; B09B 3/40; B09B 101/75; H01G 11/26; H01G 11/32; H01M 4/02; H01M 4/587

(52) U.S. Cl. CPC C01B 32/205; B09B 3/40; H01G 11/26; H01G 11/32; H01M 4/587; B09B 2101/75; C01P 2002/72; C01P 2002/82; C01P 2002/85; C01P 2002/88; C01P 2004/03; C01P 2004/04; C01P 2006/12; C01P 2006/14; C01P 2006/17; C01P 2006/40; C01P 2006/80; H01M 2004/021

(57) ABSTRACT

Polymer waste is converted to graphite and graphitic porous carbons with the aid of solid additives. The air processing developed in this invention overcomes the oxygen diffusion bottlenecks for processing bulk polymer waste, achieving char yield over three orders of magnitude compared to without using solid additives. Thermally stabilized materials can be converted into highly crystalline flake graphite via low-temperature catalytic graphitization with a very high degree of graphitization. The plastics-derived graphite showed excellent electrochemical performance as anode material for lithium-ion battery anodes, capacitors, and supercapacitors. Graphite compositions are described.

Related Applications: This application claims the priority benefit of United States Provisional Patent Applications Ser. No. 63/549,827 filed 5 Feb. 2024 and 63/575,682 filed 6 Apr. 2024.

Government Rights: This work was supported under a government contract, The United States government has certain rights in the invention.

### INTRODUCTION

Increasing graphite demand for lithium-ion batteries (LIBs) is looking toward plentiful feedstock availability to ensure supply security and an environmentally friendly approach to graphite processing.^{1,2} Chemical upcycling can be used to produce high-value and solid carbon materials from plastic waste. These carbons include 2D graphene⁴, carbon nanotubes⁶, activated carbons⁸, and porous carbons⁹. This form of upcycling diverts plastic waste from landfills, where it is a long-term environmental hazard, back into the manufacturing supply chain where the carbon is sequestered as a solid product. If the waste is used to make electrode materials for lithium-ion batteries (LIBs), supercapacitors, and hybrid supercapacitors, the carbon can potentially be recovered and reused at the end of device life to create a more circular economy from this waste stream.

Polyethylene (PE) and polypropylene (PP) make up nearly contribute 60% of the world's plastic production (400 million tons) (Sci. Adv. 3, e1700782, 2017), and are possible alternative carbon sources for the production of graphite. A primary use of PE is to make the blue-plastic shopping bags that are currently choking the environment. PP is primarily used as a general plastic for rigid and flexible consumer packaging materials. Their recycling rates are low, <6-8%, so technologies that can convert these plastic wastes to more useful products, such as graphite in a powder form, are in demand.

Current technology involves three general processing steps for upcycling plastics into solid carbon materials^{10, 13, 14}: 1) a pre-treatment or stabilization step where functionalization, cyclization, and/or cross-linking is induced by chemical treatment and/or air heating in an effort to thermally stabilize the material for carbonization and other processing at higher temperatures. Without this step, many plastics, including polyethylene (PE) and polypropylene (PP), decompose completely into light gases when heated in inert or air which creates challenges for upcycling these materials. 2) a carbonization step that involves heating a stabilized material in an inert atmosphere at relatively high temperatures to convert the polymer into a char or solid carbon. This step is often called “pyrolysis” or “calcination” in the literature; and 3) a post-treatment step where the carbonized waste may be subjected to additional thermal, catalytic, and or chemical processing to initiate microstructural changes, surface modification, and/or graphitization/graphenization to tailor the functional properties of the carbon for a specific end-use application.

A major technical challenge for upcycling plastic waste involves processing polyolefin-based plastics, such as PE and PP. Both PE and PP decompose during thermal processing in air or inert. This means the plastic decomposes at relatively low temperatures (400-500° C.) and cannot be processed at the higher temperatures required to make high-valued and useful carbons. For instance, catalytic graphitization to make lithium-ion battery-grade graphite requires the carbon to be heated to ˜1100-1500° C. and chemical activation to make porous carbons for supercapacitor electrodes requires the plastic to be heated to ˜600-1100° C.

This thermal decomposition issue is often addressed with a “pre-treatment” step (Step 1) to stabilize the material for higher temperature processing in Steps 2 & 3. For PE, this pre-treatment step involves processing the material with sulfuric acid to create sp² double bonds in the polymer chain, as well as sulfonic acid functional groups^{19, 20, 21, 26} (Fibers 2015, 3, 373; J. Am. Chem. Soc. 2013, 135, 6130; Adv. Mater. 2012, 24, 2386; Pol. ACS Appl. Mater. Interfaces, 2018, 10, 14827; Polym. Degrad. Stab. 2016, 134, 272). Heating sulfuric acid-stabilized PE causes the decomposition of sulfonic acid groups and cross-linking of PE chains, imparting better temperature stability for carbonizing PE fibers. While this approach allows PE fibers to be carbonized, it does not produce a material that easily converts into highly ordered graphite powders and the use of sulfuric acid has distinct limitations for upcycling PE waste into graphite at commercial scale. For PP, one group reports that heating PP in a molten CuCl₂ salt results in the dehydrogenation of PP which leads to aromatization & stabilization of the carbon during higher temperature processing (Chem. Eng. Sci., 2023, 270, 118559). While this approach allows PP to be upcycled, using molten salts at an industrial scale has distinct limitations.

A major technical challenge for upcycling polyolefin-based plastics, such as PE and PP is how to stabilize the material in a simple & scalable process that can be utilized for large quantities of bulk materials. Heating PE and PP in air can be used to partially oxidize the material and crosslink the plastic into a thermally stable material that can be heated well above its normal decomposition point. One technical challenge with air processing of PE and PP is that oxygen cannot easily diffuse into the bulk of the material to initiate stabilization chemistry. As a result, air stabilization of PE and PP can only be carried out on thin (less than 25 microns) films cast on planar support substrates.

Processing any form of real PE or PP plastic waste, including thin plastic shopping bags and food service gloves, will require the mixing and heating of a plastic melt which will not, under any standard circumstances, remain as a thin film but will form a bulk melt that fills the inside of the processing vessel and conforms to its shape. This will obviously limit the effective surface area of the melt that is exposed to oxygen. Therefore, it is necessary to develop simple and scalable approaches that overcome this oxygen diffusion limitation and allow this air-based stabilization chemistry to be realized in a more practical processing configuration, such as in large mixing vessels and industrial reactors.

The demand for lithium-ion batteries (LIBs) has skyrocketed in recent years due to the increasing popularity of electric vehicles (EVs) and renewable energy storage systems. Graphite is an essential material for the LIB anode, and it is essentially the only anode material used for commercial production of LIBs. Until now, petroleum-derived cokes, coal tar pitches, and mined graphite have been the primary sources for fabricating LIB electrodes (https://doi.org/10.1016/B978-0-444-63777-2.00003-7). However, petroleum-derived cokes and coal tar pitches are non-renewable resources. Processing them into graphite is very energy intensive since it requires a heat treatment between 2500-3000° C. for more than 7 days to convert the solid amorphous carbon into graphite (Advanced Energy Materials, 2020, 10, 1-8).

This process also generates high emission levels of volatile organic compounds and CO2 (20 kg per kg graphite) from the conversion of amorphous carbon to graphite. Furthermore, natural graphite is a limited resource, and the mining process is environmentally destructive. Processing mineral graphite for LIB applications often involves several steps combined with a variety of purification, milling, shaping, and/or surface treatment processes, where more than 70-90% of the material is lost during the process, and the use of highly corrosive and environmentally detrimental chemicals such as hydrofluoric acid (ChemSusChem, 2023, e202300729). Therefore, research is needed to look for other feedstocks to ensure supply chain security and an environmentally friendly approach to graphite manufacturing.

Since carbon is the major constituent of plastics, plastic waste is one possible alternative feedstock for manufacturing graphite. There are, however, extreme technical challenges associated with converting plastic materials into highly crystalline graphite. Ko et. al. have reported on the catalytic conversion of a polyethylene (PET) derived char into graphite powder achieving a graphitization degree of ˜80%.¹⁵ Ko's method has only been demonstrated on PET plastics and requires a boron catalyst, making it difficult to envision as a large-scale process for manufacturing graphite. A report by Choi et. al. described the non-catalytic graphitization of linear low-density polyethylene (LLDPE) thin films (˜25 μm) supported on substrates into graphite thin films also supported on substrates.¹⁶ Choi's method will only work on extremely thin films of LLDPE that are supported on substrates (e.g., quartz) and only produce thin graphite films, whereas the bulk powder form of graphite is needed for LIB applications. These two methods also require heating the carbonized plastics up to 2400° C., which is as high as the current method for making graphite. As such, it will require as much energy to process the plastic and will also produce a high level of volatile emissions. These characteristics make it equally difficult to envision their approach as a large-scale process for manufacturing graphite.

Three patents can be mentioned: US 2019/0198862 A1, “High performance carbonized plastics for energy storage”. A high-purity carbon fibers with a few graphitic layers were synthesized at 2500° C. without a catalyst and used as electrode materials in batteries and supercapacitors. Their product is carbon fibers which is not suitable for the LIB industry. WO 2018/186958 A1, “Methods and systems for the production of crystalline flake graphite from biomass or other carbonaceous materials”. Highly crystalline potato-shaped flake graphite was synthesized by using laser beam in catalytic graphitization of biomass. No plastic was used. U.S. Ser. No. 11/427,471 B2, “Method for preparing carbon material using polyolefin-based plastic and carbon material prepared therefrom”. Carbonized plastic was graphitized at high temperature (>2400° C.) without a catalyst.

### SUMMARY OF THE INVENTION

In one aspect of the invention, PE and/or PP are used to synthesize a highly crystalline graphite powder. Solid additives that are mixed with the PE or PP melt during the pre-treatment (or stabilization) step. This method coats the solid additive with a thin film of the PE or PP melt, enables facile oxygen diffusion into the polymer for functionalization and thermal stabilization, and increases the effective surface area of the melt during processing. Without the solid additive, oxygen diffusion into the PE or PP bulk is limited, oxidative stabilization is essentially non-existent, and the PE or PP decomposes during high-temperature processing. This method allows, for the first time, the pre-treatment (or stabilization) of bulk forms of PE or PP wastes using a simple air processing method. We use a similar method to process bulk melts of LLDPE, low-density polyethylene (LDPE), and high-density polyethylene (HDPE), which illustrates the approach is general enough for use with real PE or PP-based waste streams. We also demonstrate that bulk forms of PE or PP wastes can be converted into highly crystalline bulk graphite powder that is of suitable crystallinity, morphology, and microstructure for use in LIB anodes. Bulk forms of PE or PP waste are converted to a graphite powder that can be used as a drop-in replacement for the synthetic graphite currently used to manufacture commercial LIBs.

In another aspect, the invention provides a process of transforming waste plastic into graphite, comprising: providing waste plastic comprising PE and PP; adding a solid particulate additive; and combining the waste plastic with the solid additive; and heating the waste plastic to a temperature of at least 300° C. to form a molten mixture with the solid additive and mixing the molten mixture with the solid additive while exposing the molten mixture to gaseous oxygen; wherein the solid additive remains as a solid during the step of exposing the molten mixture to gaseous oxygen.

In a further aspect, the invention provides a thermally stabilized carbon char that is characterized by one or any combination of the following: at least 10 or at least 20 or at least 30 atomic percent of oxygen; characterizable by one or any combination of the data provided herein.

In another aspect, the invention provides a graphite powder, comprising: high lateral size (Lₐ) to clustering size (L_{c}) ratio (La/Lc=>1.9), low ash (<0.1 wt %), low surface area (<5 m²/g), and a number average particle size of 1 mm or less. In yet another aspect, the invention provides a graphite powder, comprising: high lateral size (Lₐ) to clustering size (L_{c}) ratio (La/Lc=>1.9), low ash (<0.1 wt %), specific surface area of >1800 m²/g. Preferably, the powder comprises graphene layers (Nc) between 137 and 155 and/or high 2H/3R ratio (>60/40) and/or graphene layers (Nc) greater than 20, and/or high 2H/3R ratio (>60/40), and/or high purity (>99.5% carbon). Graphite is characterized by stacks of at least ten layers and not curled into tubes of 1 μm or less).

In a further aspect, the invention provides a process of transforming waste plastic, comprising: providing waste plastic; adding a solid particulate additive; and combining the waste plastic with the solid additive; and heating the waste plastic to a first temperature of at least 300° C. to form a molten mixture with the solid additive and mixing the molten mixture with the solid additive while exposing the molten mixture to gaseous oxygen; wherein the solid additive remains as a solid during the step of exposing the molten mixture to gaseous oxygen to produce an oxygen-treated product; and after an optional comminution step; heating the oxygen-treated product in vacuo or an inert atmosphere at a second temperature of at least 600° C.; removing the solid additive; and recovering a porous carbon material.

In any of the aspects, the invention can be further characterized by one or any combination of the following: following the step of exposing to oxygen, heating to at least 500° C. or heating to a temperature in the range of 500 to 1500 or 800 to 1500 C; heating to at least 800° C. and forming graphite; forming a lithium ion battery anode from the graphite (note that the terms “graphite” and “carbon nanotubes” have their conventional meanings); solid additives comprises salts (NaCl, KCl), chars (coal char, biochar, etc.), catalytically-active agents (K₂CO₃, etc.), metal oxides (iron oxide, nickel oxide, etc), and/or inert solid (sand) in the air processing; wherein the solid additives are water soluble and removed from the composition by washing with water; wherein the waste plastic contains, or is pre-treated to contain, at least 90 wt % or at least 95 wt % or at least 98 wt % of PE or PP or a combination of PE and PP; the PE is LLDPE; creating core-shell type functional materials that are coated with a carbon shell made from PE or PP (e.g., Nickel particles coated with graphite, carbon nanotubes coated with graphite, carbon nanotubes coated with porous carbons); wherein the graphite is formed at a temperature of 1500 C or less for a period of 10 hours or less, or 7 hours or less, or 5 hours or less, or in the range of 1 to 10 hours; use of solid additives with porous characteristics, such as zeolites and metal-organic frameworks, to improve their electrical/thermal conductivity; use of solid additives that exhibit plasmonic behaviors for sensor application (core-shell); use of functional solid particles that can graft with carbon materials; use of metal or alloy particles resulting in a composite layer; use of high pressure significantly above (at least 3 atm, at least 10 atm) or below ambient conditions in air processing; use of solid additives combined with other heating sources (hot air, concentrated solar energy) or light sources (ultraviolet) to accelerate stabilization speed or induce different types of carbon materials in air processing; use of solid additives that absorb microwave energy for heating the plastic melt; wherein the waste plastic comprises other plastics (e.g., polyethylene terephthalate, polyvinyl chloride, polystyrene, polyurethane, tires) as a carbon feedstock in the catalytic graphitization process; wherein the waste plastic comprises carbonizable plastics or non-carbonizable plastics or thermoplastics or non-thermoplastics or non-recyclable plastics (e.g., eyeglasses, sports bottles, electronics, CD/DVDs, lighting fixtures, and clear plastic cutlery) as carbon feedstock in the catalytic graphitization process; wherein the waste plastic comprises blended carbon feedstock, mixing plastics with biomass, coals, or carbonaceous materials, in the catalytic graphitization process; the step of exposing the molten mixture to gaseous oxygen is conducted at a temperature in the range of 310° C. to 550° C., or 320° C. to 500° C., or 320° C. to 400° C., or 320° C. to 360° C.; the second temperature is in the range of 700° C. to 1200° C., or at least 800° C., or at least 900° C., and up to 1100° C. or up to 1000° C.; the heat treatment is at least 30 minutes or at least an hour or at least 2 hours; the step of heat the oxygen-treated product is preferably a gradual increase in temperature such as a step-wise increase such as heating in the range of 400 to 550° C. for 20 min to 2 hours, followed by heating in the range of 560 to 800° C. for 20 min to 2 hours, followed by heating in the range of 800 to 1000° C. for 20 min to 2 hours; wherein the solid additives comprise water-soluble salts (preferably NaCl and/or KCl), chars (coal char, biochar, etc.), catalytically-active agents (K₂CO₃, etc.), metal oxides (iron oxide, nickel oxide, etc), and/or inert solid (sand) in the air processing; wherein the solid additives are added in a weight ratio of waste plastic/solid additive of from 1:30 to 1:4 or 1:20 to 1:6; wherein a preferred solid additive comprises from 5 to 30 wt % of one or more carbonates (as a percent of solid additive); wherein the solid additives are water soluble and removed from the composition by washing with water; wherein the waste plastic comprises carbonizable plastics or non-carbonizable plastics or thermoplastics or non-thermoplastics or non-recyclable plastics (e.g., eyeglasses, sports bottles, electronics, CD/DVDs, lighting fixtures, and clear plastic cutlery) as carbon feedstock in the process; use of pressure at least 20% above, or at least 10% below ambient conditions in air processing, or at least 3 atm, at least 10 atm above ambient pressure; use of solid additives that absorb microwave energy for heating the plastic melt; wherein the waste plastic comprises other plastics (e.g., polyethylene terephthalate, polyvinyl chloride, polystyrene, polyurethane, tires) as a carbon feedstock in the catalytic graphitization process; wherein the solid additives are recovered and recycled, preferably recycled at least 3 times or at least 5 times; recycling of the solid additives does not have a detrimental affect on the process or resulting product; wherein the yield (based on weight % of waste plastic) is at least 5% or from 5 to 15% or 5 to 10%; and/or wherein the solid additive comprises various metals (e.g., Ni, Co) or metal oxides (e.g., NiO, Co₃O₄) or soluble metal salts (e.g., FeCl₂, Fe(NO₃)₂) or combination metals, alloy, combination of alloys or combination of alloy and metal, as catalysts, for synthesizing graphite powder.

The invention also includes articles that comprise the inventive graphite such as fuel cells, supercapacitors, or batteries. The invention also includes a thermally stabilized carbon char; porous carbon material; or graphite made by any of the methods described herein. The invention also includes any of the intermediate materials, for example porous carbon material comprising solid additives. The invention also includes a porous carbon material that is characterizable by one or any combination of the data provided herein; for example, a BET surface area of at least 1700 m²/g or at least 1800 m²/g or in the range of 1780 m²/g to 1820 m²/g. Within ±10%, ±20%, or 30% of 1800 m²/g; a total pore volume 0.8 to 1.2 cm³/g or at least 0.9 cm³/g; as determined by QSDFT micropores in the bimodal pore distribution in the range of 0.5 to 1.5 nm and 2.0 to 3.0 nm, or within ±10%, ±20%, or ±30% of the volume ratios of the pores between (0.5 nm to 1.5 nm) and (2.0 nm and 3.0 nm) as determined by the integrated intensities as determined by QSDFT (see below).

The invention also includes a method of storing energy, comprising applying a voltage to a capacitor, supercapacitor or battery comprising any of the porous carbon materials. The invention also includes articles that comprise, or at made from, the porous carbon material such as electrodes, supercapacitors, or capacitor (preferably zinc-ion hybrid capacitor). In another aspect, the invention provides a capacitor that is characterizable by one or any combination of the following properties: within ±10%, ±20%, or ±30% of 175 A/g specific capacity and/or 7.86 Wh/kg energy density and/or a capacity retention of at least 90% or up to about 96% after 100,000 cycles at a current density of 4.0 A/g.

The porous carbon material is preferably graphenic. A graphenic material is characterizable by at least 40%, or at least 50%, or about 60% or 50 to 70% sp² carbon component in the x-ray photoelectron spectrum. The yield of graphemic material is (as a wt % of C in the waste plastic) preferably at least 5%, or at least 7%, or in the range of 5 to 10%. The powder preferably comprises graphene layers (Nc) between 137 and 155 and/or high 2H/3R ratio (>60/40) and/or graphene layers (Nc) greater than 20, and/or high 2H/3R ratio (>60/40), and/or high purity (>99.5% carbon).

The invention provides a simple air processing method for the oxidative stabilization of bulk PE and PP, so these materials can be carbonized and graphitized at higher temperatures. Without oxidative stabilization, PE and PP decompose completely during carbonization and graphitization. One challenge with air processing PE and PP involves the limited diffusion of oxygen into the bulk PE and PP melt, which also limits the oxidative stabilization of this material. The innovation described in this work overcomes this challenge by utilizing solid additives, which are added to PE or PP melts during the oxidative stabilization step to provide a surface for the polymer melt to wet as a thin layer, so oxygen can readily and consistently diffuse into the polymer melt. Using this approach, we stabilize bulk PE and PP melts for higher temperature processing and, after carbonization, reach char yields as high as 20 wt %, which is over three orders of magnitude higher than what occurs without the solid additive.

Graphite powders produced with this process exhibit a high DG %, where interlayer spacings, La and Lc values, 2H/3R ratios, and Raman spectra are indicative of an extremely well-ordered and conductive graphite material. BET, TGA, and elemental analysis demonstrate a low-surface area graphite powder with high compositional purity that further illustrates the quality of the graphite powder produced from bulk waste. The highly crystalline PE or PP-derived graphite was used to fabricate a coin-type half-cell LIB. The PE-derived graphite anode initially delivers a specific capacity of 442 mAh/g at 0.1 C, then delivers a high reversible capacity of 318 mAh/g at 0.2 C with a capacity retention of nearly 100% CE after 50 cycles. Furthermore, the specific capacity was enhanced from 274 to 302 mAh/g after 415 cycles at 0.5 C, improving the accessibility of lithium ions in the carbon layers during cycling. As a result, the graphite anode shows a reversible rate performance and outstanding long-term cyclic stability, comparable to current-use battery-grade graphite.

The invention, in various embodiments, can provide advantages such as: the graphite produced with this invention is suitable as a “drop-in” replacement for the graphite powders currently used in the LIB industry; any applications needing high-quality graphite; some preferred applications include LIB, but are not limited to other batteries such as lead-acid batteries, alkaline batteries, and thermal batteries; graphite in fuel cells;
Flake graphite is also an essential part of vanadium-redox battery technology, with nearly 300 tons of flake graphite required per 1,000 megawatts of storage. The unique properties of vanadium and graphite combined allow for the long-term storage of excess energy.
Pebble-bed nuclear reactors, which use uranium embedded in fist-sized graphite balls, are another example of how important graphite is becoming to the energy sector. Just one 100 GW pebble-bed nuclear reactor requires 300 tons of graphite to start initial production, followed by an additional 60 to 100 tons per year for continual operation.
the ability to produce oxidized plastics (or charred plastics) exhibiting 0.1-100 microns thick and 1-1000 micron-sized plates;
the ability to produce oxidized plastics containing more than 30 atomic percent of oxygen;
the ability to significantly improve the char yield (˜24 wt %), over three orders of magnitude higher than those without solid additives;
the ability to use various solid additives, such as salts (NaCl, KCl), chars (coal char, biochar, etc.), catalytically-active agents (K₂CO₃, etc.), metal oxides (iron oxide, nickel oxide, etc), and inert solid (sand) in the air processing;
the ability to produce a feedstock from plastics for synthesizing the highly crystalline graphite powder, possessing high lateral size (Lₐ) and clustering size (L_{c}) ratio (La/Lc=>1.9), low ash (<0.1 wt %), low surface area (<5 m²/g), and millimeter size;
the ability to produce a feedstock from plastics for synthesizing the porous carbons with a specific surface area of >1800 m²/g for a high areal capacitance supercapacitor;
the ability to produce a feedstock from plastics for a low-temperature catalytic graphitization process (below 1500° C.);
the ability to produce a feedstock from plastics for upgrading to a range of high-value carbon products; or
can be used to produce carbon feedstock from plastics for any applications where carbon materials are needed as electrodes for energy conversion and storage. A few apparent uses include batteries (lithium-ion, sodium-ion, potassium-ion, lithium-sulfur, zinc iodine, metal-air, thermal batteries), supercapacitors (lithium-ion hybrid, zinc-ion hybrid capacitors), polymer electrolyte membrane-type fuel cells, and electrochemical sensors;
can be used to produce a feedstock from plastics for gas adsorption, water purification, and soil remediation;
can be used to coat particulate and nano-particulate materials with plastic melts, stabilize the melt by means of oxidative chemistry, and later graphitize/graphenize the material to create unique core-shell materials;
can be applicable to a broad range of plastics and plastics melts for other forms of plastic upcycling; This invention, in various embodiments, can provide unique features/advantages selected from:
the ability to synthesize highly crystalline flake graphite from PE or PP or real PE mix plastics via a low-temperature (<1500° C.) catalytic graphitization process that can be completed within a few hours;
the ability to synthesize highly crystalline flake graphite with a graphitization degree of >97% from PE or PP or real PE mix plastics;
the ability to synthesize highly crystalline graphite powder, possessing high lateral size (La) and clustering size (Lc) ratio (La/Lc=>1.9), high 2H/3R ratio (>60/40), low ash (<0.1 wt %), low surface area (<5 m²/g), high purity (>99.5% carbon), and micro-to-millimeter size;
the ability to synthesize flake graphite with a graphene layer higher than 100 or 150 from plastics.
the ability to synthesize a highly crystalline graphite with either hexagonal or angular edges and high aspect ratios greater than 5 or 10 or 20 or 50;
the ability to synthesize highly crystalline graphite powder, yielding 15-18 wt % from plastics.
the ability to use metal (Fe) or metal oxide (Fe₂O₃) in catalytic conversion of PE, PP, or real PE mix into graphite synthesis;
the ability to synthesize a highly crystalline micrometer to millimeter scale flake graphite that is suitable for use in commercial devices;
the ability to produce graphite powder that does not require extra processing, such as purification or shaping, for battery application.—the ability to synthesize graphite anodes that exhibit reversible capacities at various current rates and are better than commercially available graphite;
the ability to provide an environmentally friendly route for plastic upcycling into value-added carbon materials.
production of graphite for pencils, lubricants, crucibles, foundry facings, polishes, arc lamps, batteries, brushes for electric motors, and/or cores of nuclear reactors;
flake graphite applications including but not limited to powder metallurgy, fuel cell bi-polar plates, coatings, thermal materials, friction moderators, electrically conductive materials, refractories, general lubricant applications, pencils, gaskets, rubber compounds, and other advanced polymer systems; and/or
synthetic graphite is used in many applications, including but not limited to friction, foundry, electrical carbons, fuel cell bi-polar plates, coatings, electrolytic processes, corrosion products, conductive fillers, rubber and plastic compounds, and drilling applications.

The invention may be further characterized by any of the data presented herein. For example, any of the inventive aspects can be described as possessing one or any combination of the properties and/or compositions (or within ±10%, ±20%, or ±30% of one or any combination of the properties (as shown in the data, tables, and figures) and/or compositions) described herein. All ranges are inclusive and combinable. For example, when a range of “1 to 5′ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

### BRIEF DESCRIPTION OF THE DRAWINGS

FIG. 1. Schematic illustration of the mechanism of bulk plastics oxidation using solid additive.

FIG. 2. Effect of solid additive in air processing of bulk LLDPE. (a) without and (b) with NaCl as a solid additive.

FIG. 3. Characterization result of oxidized LLDPE. (a) XRD patterns, (b) Raman spectra, (c) FT-IR spectra, (d) elemental analysis, (e) SEM images (scale bar is 200 um), and (f) TGA data of pristine and thermal oxidatively stabilized bulk LLDPE with solid additive. Temperatures in FIGS. a-c are plotted in ascending order from the lowest temperature plotted on the bottom of each figure.

FIG. 4. SEM images of (a) NaCl solid additive and (b) charred LLDPE 6 cycled (scale bar is 200 um).

FIG. 5. Characterization result of oxidized PE and PP. (a) XRD patterns, (b) Raman spectra, (c) FT-IR spectra, (d) elemental analysis, and (e) TGA data of thermal oxidatively stabilized bulk PEs with solid additive. (f) SEM and EDS analysis of the o-Real LDPE sample (scale bar is 10 um). TiO₂ phase was observed in the o-Real LDPE sample. This is due to the presence of inorganic colorants in real LDPE packing material. Temperatures in FIGS. a-c are plotted in ascending order from the lowest temperature plotted on the bottom of each figure.

FIG. 6. Characterization result of charred PE and PP. (a-e) SEM images (scale bar is 100 um) and (f) Elemental analysis and of charred PE and PP after heating o-PE and o-PP samples to 800° C. under Ar.

FIG. 7. Characterization result of o-PE graphite. (a) XRD patterns of the o-PE graphite. The inset shows the deconvolution results of the (002) peak. SEM images (b) from above and (c) from the edge on of o-LLDPE graphite (scale bar is 5 μm), (d) Raman spectra (LLDPE is upper plot), and (e) TGA curves in air of the o-LLDPE graphite and MSE natural graphite.

FIG. 8. (a) SEM images (scale bar is 40 m) and (b) XRD patterns PE or real PE mix-derived graphite synthesized with Fe₂O₃ catalyst.

FIG. 9. The initial discharge/charge profiles of o-LLDPE graphite and commercial graphite anodes at a current rate of 0.1 C in the voltage window between 0.01 and 2.5 V.

FIG. 10. Electrochemical performance of o-LLDPE graphite anode. (a) CV curve of o-LLDPE graphite anode. Cycling performance of the (b) commercial graphite and o-LLDPE graphite anodes at various current rates. (c) Long-term cycling performance of the o-LLDPE graphite anode at current rates of 0.2 C and 0.5 C (specific capacity is lower plot).

FIG. 11: Schematic illustration of synthesis procedure of upcycling LLDPE waste into graphene.

FIG. 12. (a&b) SEM images, (c) TEM image, (d) Raman, (e) XPS C1s, and (f) nitrogen adsorption-desorption isotherms and Quenched solid density functional theory (QSDFT) pore size distribution (inset) of LLDPE-G.

FIG. 13. Electrochemical properties of LLDPE-G supercapacitors with mass loading of 5, 10 and 20 mg cm⁻² (a) CVs at different scan rates, (b) CVs at scan rate of 25 mV s⁻¹, (c) Galvanostatic charge discharge curves at 1.0 A g⁻¹, (d) electrochemical impedance spectroscopy, (e) gravimetric specific capacitance, (f) areal specific capacitance, (g) Ragone plot, and (h) cycling stability at current density of 4.0 A g⁻¹.

FIG. 14. Electrochemical properties of LLDPE-G and commercial SOT YP-50F supercapacitors at mass loading of 20 mg cm⁻² using 1M H₂SO₄ electrolyte: (a) CV at scan rate of 25 mV s⁻¹, (b) Galvano-charge/discharge curves at current density of 1.0 A g⁻¹, (c) impedance, (d) rate capacity and (e) cycling stability at current density of 4.0 A g⁻¹.

FIG. 15. (a, b & c) SEM images and (d, e & f) TEM images of LLDPE-G-Re1, LLDPE-G-Re2, and LLDPE-G-Re3, respectively.

FIG. 16. (a) Raman spectra and (b) nitrogen adsorption-desorption isotherms of LLDPE-G-Re1, LLDPE-G-Re2, and LLDPE-G-Re3.

FIG. 17: Schematic illustration of synthesis procedure of upcycling mixed PE wastes into hybrid graphitic porous carbons.

FIG. 18. (a-c) SEM images, (d) Raman, (e) XPS C1s, and (f) nitrogen adsorption-desorption isotherms and QSDFT pore size distribution (inset) of PE-HGPC.

FIG. 19. Electrochemical properties of PE-HGPC and commercial SOT YP-50F as cathode materials for zinc-ion hybrid capacitors: (a) CV at scan rate of 10 mV s⁻¹, (b) Galvano-charge/discharge curves at current density of 1.0 A g⁻¹, (c) rate capacity and (d) cycling stability at current density of 2.0 A g⁻¹.

FIG. 20. SEM images of PE-HGPC-Re1 (a&b), PE-HGPC-Re3 (c&d), and PE-HGPC-Re5 (e&f).

FIG. 21. (a) Raman spectra and (b) nitrogen adsorption-desorption isotherms of PE-HGPC-Rex.

### DETAILED DESCRIPTION

To stabilize bulk plastics, we utilize solid additives as a surface area enhancer. The solid additives are an effective tool to be utilized for processing bulk plastic waste, where a solid additive helps diffusion of oxygen into the bulk plastic during the oxidative stabilization step. Without the solid additive, oxygen diffusion into the bulk plastic is limited, oxidative stabilization is essentially non-existent, and the plastic decomposes during high-temperature processing. This method allows the pre-treatment stabilization of bulk forms of plastic using a simple air processing method. Bulk plastic feedstocks were thermally oxidized in a beaker in the presence of the solid additives. Two-blades and a shaft impeller were used to mix the plastic melt with solid additives. After the air processing, the mixture was heated at 800° C. for 1 hr in Ar or N₂ flow to produce carbon char, then cooled to room temperature, followed by removal of the solid additives.

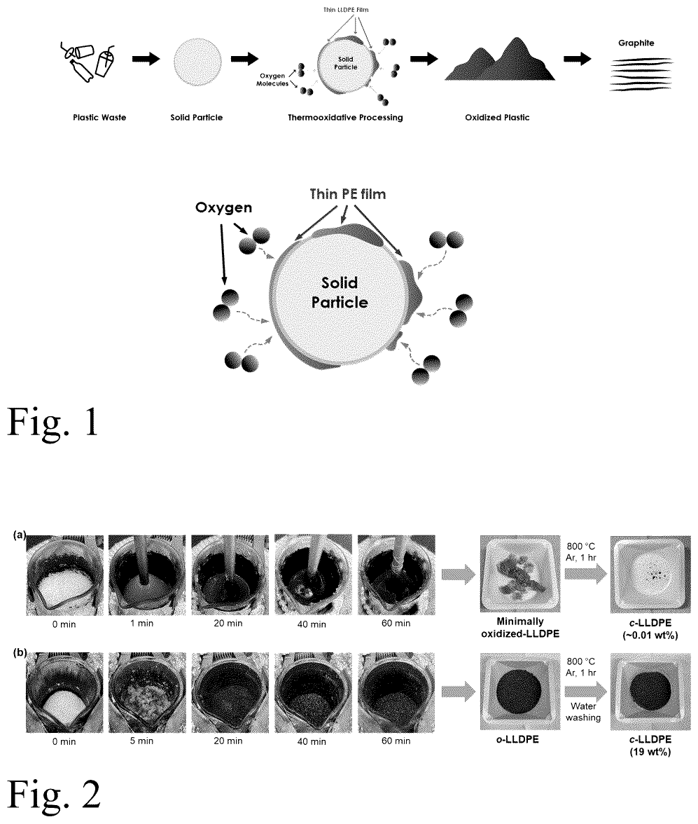

The role of the solid additive is to provide a surface for the polymer melt to wet, in a thin layer, where oxygen can readily diffuse into the polymer melt (FIG. 1) and initiate the oxidative chemistry needed to stabilize the plastic melt for higher temperature processing. The ability to physically mix the solid additive and plastic melt mixture during air processing with a standard laboratory impeller constantly refreshes the thin plastic film on the substrate and effectively increases the surface area of the mixture so the plastic is constantly exposed to fresh oxygen to drive the stabilization chemistry. The differences between processing the LLDPE with and without the solid additive are stark and indicate the critical role the solid additive has on the process.

To illustrate the oxygen diffusion challenge, we heated bulk quantities of LLDPE to 270-310° C. in a beaker and physically stirred the melt using a standard laboratory two-blade impeller to simulate how bulk quantities of plastic would be processed (FIG. 2a). From the photos of the LLDPE melt during air oxidation, we note the polymer does not quickly oxidize. Even after 60 minutes of oxidation, the material recovered from the reaction flask maintains a light amber to brown color, indicating poor oxidative stabilization. Furthermore, attempts to carbonize this material at 800° C. under inert causes the material to decompose, leaving little carbonized residue (FIG. 2a). This result illustrates it is impossible to air-stabilize bulk quantities of plastic unless this oxygen diffusion limitation is addressed.

We addressed this technical challenge by adding a simple solid additive as a surface area enhancer to the plastic melt while the sample is being air stabilized (FIG. 2b). As a first example, we demonstrate the method by adding NaCl salt to the LLDPE melt while it is being heated to 310° C. in air. In comparison to FIG. 2a where no NaCl salt is used, the photos clearly show that the LLDPE melt wets the NaCl particles and the melt mixture quickly turns black as the polymer oxidizes during air stabilization. The NaCl and LLDPE melt mixture is easily stirred with a standard laboratory impeller. Additionally, the recovered product from the reaction beaker is a well-oxidized black powder (FIG. 2b). The recovered oxidized LLDPE (o-LLDPE) is carbonized at 800° C. under inert and then rinsed with water to remove the NaCl salt, providing a 19% by mass yield, with respect to the starting quantity of LLDPE, for the example shown in FIG. 2b.

Table 1 summarizes the different experimental conditions for the stabilization of bulk plastics. Table 1 shows that NaCl, KCl, sand, and coal char can all be used as solid additives in this process. The use of sand as an inert solid additive illustrates that the role of the solid additive, in this set of samples, is to provide a solid surface for the polymer to wet and increase the effective surface area of the mixture. Sand was only used to demonstrate that the NaCl, KCl, and coal char did not have catalytic roles in the stabilization process. Additionally, the use of coal char as a solid additive illustrates it should be possible to use this method to coat particulate and nano-particulate materials with plastic melts, stabilize the melt by means of oxidative chemistry, and later graphitize/graphenize the material to create unique core-shell materials. Furthermore, the air processing of the bulk plastic can continue to function efficiently for several cycles through successive additions of the bulk plastic, which were performed with no further solid additive additions between cycles.

TABLE 1
Various experimental conditions for the bulk oxidation of plastics

| | | | | | | Additive | | |
|---|---|---|---|---|---|---|---|---|
| | | | | | Ratio | sizes | o-Plastic | Char |
| | Type of | | Times | Solid | (Plastic:solid | (averaged, | yield | yield |
| Entry | plastic | Temperature(° C.) | (hr) | additive | additive) | μm)^{a} | (wt %) | (wt %) |
| 1 | LLDPE | 310 | 1 | No | — | — | — | 0.01 |
| | | | | solid | | | | |
| | | | | additive | | | | |
| 2 | | 270 | 1 | NaCl | 1:10 | 350 | 56 | 13 |
| 3 | | 290 | 1 | NaCl | 1:10 | 350 | 50 | 16 |
| 4 | | 310 | 1 | NaCl | 1:10 | 350 | 37 | 19 |
| 5 | | 330 | 1 | NaCl | 1:10 | 350 | 21 | 10 |
| 6 | | 310 | 0.5 | NaCl | 1:10 | 350 | 36 | 17 |
| 7 | | 310 | 1.5 | NaCl | 1:10 | 350 | 30 | 17 |
| 8 | | 310 | 1 | NaCl | 1:5 | 350 | 40 | 16 |
| 9 | | 310 | 1 | NaCl | 1:20 | 350 | 30 | 19 |
| 10 | | 310 | 1 | NaCl | 1:10 | 40 | 42 | 24 |
| 11 | | 310 | 1 | NaCl | 1:10 | 15 | 7 | 4 |
| 12 | | 310 | 1 | KCI | 1:10 | 130 | 35 | 20 |
| 13 | | 310 | 1 | Coal | 1:5^{b} | 350 | 43 | 15 |
| | | | | char | | | | |
| 14 | | 310 | 1 | Sand | 1:10 | 350 | 27 | 11 |
| 15 | LDPE | 310 | 1 | NaCl | 1:10 | 350 | 42 | 17 |
| 16 | HDPE | 310 | 1 | NaCl | 1:10 | 350 | 55 | 18 |
| 17 | PP | 270 | 1 | NaCl | 1:10 | 350 | 13 | 6 |
| 18 | Real | 310 | 1 | NaCl | 1:10 | 350 | 63 (35) | 14 (18) |
| | LLDPE | (320) | | | | | | |
| 19 | Real | 310 | 1 | NaCl | 1:10 | 350 | 50 | 20 |
| | LDPE | | | | | | | |

^{a}Determined from the SEM images.
^{b}The ratio of plastic to coal char was 1:5 due to the low density of char.

Table 1 also shows that the solid additive process also works with other plastics (LDPE and HDPE), as well as real LLDPE and real LDPE waste samples collected from consumer packaging materials. The o-plastic yields in Table 1 vary from 7-63 wt %, and the resulting carbonized material yields vary from 4-24 wt %. The char yields in Table 1 are calculated relative to the mass of the starting plastic material. Table 1 illustrates that a wide range of plastic waste materials can be processed with this approach. There are many possible variations for the solid additive material.

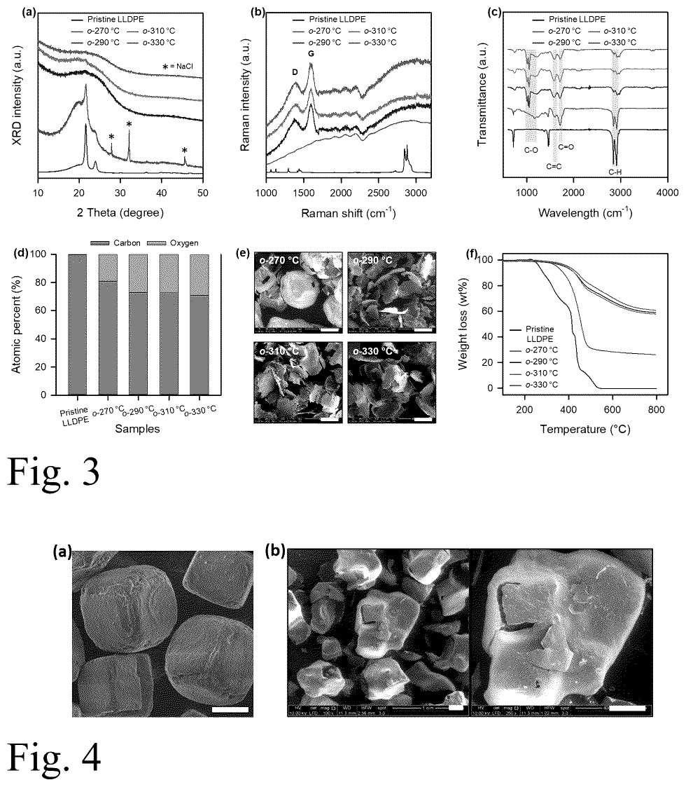

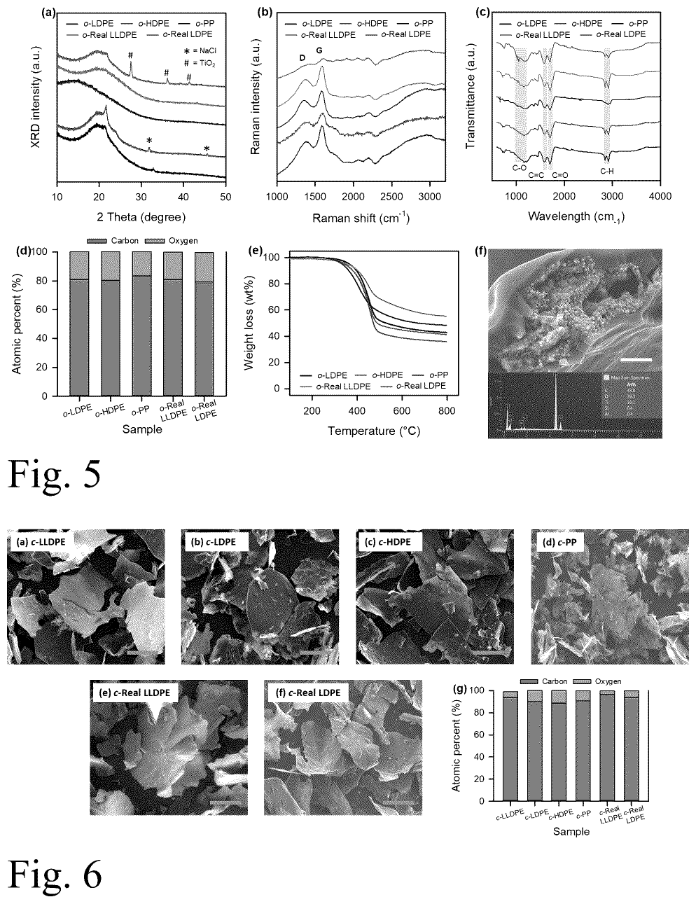

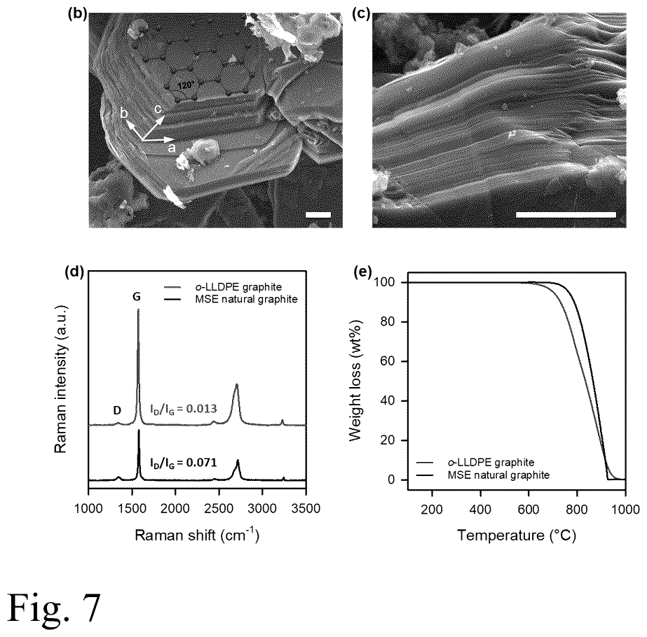

We have characterized the recovered o-LLDPE after rinsing with water to remove the NaCl salt to provide further insight into the oxidative chemistry that leads to stabilization (FIG. 3). The XRD analysis indicates the pristine LLDPE has sharp peaks consistent with orthorhombic LLDPE crystals. These peaks broaden and disappear as the sample is heated (FIG. 3a). Additionally, a new feature appears at around 2θ=20 degree that broadens with temperature, shifts to ˜24 degree, and was previously associated with a polyaromatic ladder structure that forms during the oxidative stabilization of LLDPE. We point out that the NaCl peaks in the XRD pattern for the 270° C. sample arise from the encapsulation of LLDPE around NaCl crystals at this temperature, preventing the water rinsing step from completely cleaning salt from the sample. We do not observe this encapsulation effect for samples processed at higher temperatures. The carbon structural changes noted in the XRD are also supported by Raman spectra, which show vibrations for C—H bonds that disappear after oxidative stabilization to produce the D and G modes characteristic of polyaromatic carbons (FIG. 3b). The infrared spectra show characteristic peaks at 2916 and 2849 cm⁻¹ for —CH₂ asymmetric stretching vibrations that disappear and give way to vibrational modes associated with C═C (1580 cm⁻¹), C═O (1700 cm⁻¹), C-O (1050-1150 cm⁻¹) chemical bonds (FIG. 3c). Elemental analysis shows that the oxygen content in o-LLDPE increased with sample processing temperature (FIG. 3d). In addition, scanning electron microscopy (SEM) images illustrate that the morphology of the o-LLDPE contains micron-sized plates with a 2-5 micrometer thickness formed on the surface of NaCl crystals (FIG. 3e). TGA analysis shows that the o-LLDPE samples are thermally stable and do not readily decompose when heated above 500° C. (FIG. 3f). All of these results are consistent with previous work (Chem. Mater. 2017, 29, 9518-9527) that outlined a pre-treatment stabilization mechanism where plastic is initially oxidized during air heating and later undergoes structural transformation to form an oxidized and cyclized ladder structure that is stable at high temperatures. As a result, the characterization results indicate that the solid additive surface area enhancers used in the pre-treatment process overcome the oxygen diffusion limitation, resulting in well-stabilized materials derived from bulk plastic melts. Additional characterization data for the oxidized PE and PP prepared at 310° C. for 1 hour and carbonized PE and PP materials prepared by heating the o-PE and o-PP samples to 800° C. under inert are shown in FIGS. 4-6.

### Characterization Results of Oxidized and Carbonized PE and PP

To further illustrate the utility of the solid additive process for making value-added carbons, PE-derived materials were directly used as a feedstock for synthesizing graphite in a Fe-based catalytic graphitization process (see details in the Experimental Section). Graphite samples below are denoted based on whether they are derived from oxidized or carbonized PE material, e.g., o-LLDPE graphite or c-LLDPE graphite. The structural properties of graphite were assessed with XRD with a parallel beam optic system, which allows us to quantify the amorphous, turbostratic, and graphitic carbons in the sample and estimate the DG % (FIG. 7a; Table 2). All o-PE graphite samples show a strong and sharp (002) peak at 2θ≈26.5°, indicating a high degree of carbon layer stacking along the c-axis to the graphene plane. Deconvolution of the (002) peak for o-LLDPE graphite, c-LLDPE graphite, and o-Real LLDPE graphite reveals a highly ordered graphitic carbon, with only a small trace of turbostratic carbon occurring in the o-LDPE graphite, o-HDPE graphite, and o-Real LDPE graphite samples. The interlayer spacing of o-PE graphite samples ranges from 0.33567 to 0.33647, which is close to the ideal interplanar d-spacing of graphite of 0.3354 nm (Table 2). This produces a high DG % ranging from 88-97% for these samples. L_{c} and Lₐ for the graphite samples estimated from the (002) and (101) peak widths using the Scherrer equation ranged from 46-52 nm and 46-98 nm, respectively (Table 2). Synthetic graphite generally exhibits a mixture of the hexagonal ABAB (2H) and rhombohedral ABCA (3R) structures, in which the 3R phase is a semiconductor and is less stable than the 2H.²² A higher 2H/3R ratio in the graphite structure offers better electrical conductivity and allows for effective intercalation/de-intercalation of lithium ions when charging/discharging a cell. The ratio of the 2H/3R was therefore estimated from the areas under the (101) peaks at 2θ≈44.6° for the 2H and 2θ≈43.5° for the 3R phase (Characterization data are provided in Figure B4). The ratio of 2H/3R varied between 57/43 and 82/18 for all o-PE graphite samples, with the o-LLDPE graphite ratio (82/18) being comparable to commercial battery-grade graphite (SP-1 natural flake graphite, MTI artificial graphite, and MSE natural graphite).

FIG. 7b shows a representative SEM image for o-LLDPE graphite. o-LLDPE graphite sample reveals highly crystalline flat and plate-like particles with either hexagonal or angular edges. When the basal surface is examined more closely, it is found to be fully intact and smooth across large areas (˜50 micrometers). Only some small surface steps and ridges are noticeable in the image. When the edge structures are inspected, fairly flat and long-range orders across distances of several tens micrometers, where the 1200 of the edge is readily identifiable as the perfect crystalline structure of graphite (FIGS. 7b and 7c). Based on the smooth, flat basal surface across the entire flake width and the large, regular edge faces, a highly ordered and crystalline graphite structure is evidenced across the entire flake.

The o-LLDPE graphite was also characterized by nitrogen isotherm porosimetry, Raman, and TGA. These results are summarized in Table 2. The Raman spectrum of the o-LLDPE graphite is consistent with a well-ordered sp² hybridized carbon with a representative spectrum for o-LLDPE shown in FIG. 7d. Compared to natural graphite, I_{D}/I_{G}=0.230 (FIG. 7d; Table 2), o-LLDPE graphite has an extremely low I_{D}/I_{G} ratio (0.013), indicating a very high degree of in-plane order. This likely arises from the sizeable crystalline size, minimizing the contribution of crystallite edges to the spectra.²⁹ The S_{BET} ranges from 1.12-9.97 m²/g, comparable to commercial graphite. The structural stability and purity of graphite samples were investigated with TGA (FIG. 7e). The oxidation of the carbon framework in o-LLDPE graphite started at 650° C., and the complete oxidation temperature was observed at −950° C., which is slightly higher than natural graphite (˜920° C.). The residue at 1000° C. was mostly less than 0.2 wt % for all o-PE graphite samples, while o-Real LDPE graphite contains high ash (Table 2), which is due to the presence of inorganic colorants in real PE packing material. Elemental analysis showed that the o-PE graphite samples were comprised of nearly 100% carbon (>99 at %) (Table 2).

TABLE 2
Physical properties of the PE and PP-derived graphite synthesized with Fe catalyst

| | d₍₀₀₂₎ | DG | L_{c} | Lₐ | N_{c} | 2H/3R | S_{BET} | Ash | Fixed carbon | Graphite Yield |
|---|---|---|---|---|---|---|---|---|---|---|
| Carbon source | (nm)^{a} | (%)^{a} | (nm)^{a} | (nm)^{a} | (—)^{a} | (%)^{a} | (m²/g)^{b} | (wt %)^{c} | (at %)^{d} | from PE (wt %) |
| LLDPE | 0.33567 | 97 | 52 | 98 | 155 | 82/18 | 2.60 | 0.16 | 99.7 | 15 |
| LDPE | 0.33620 | 91 | 46 | 48 | 137 | 57/43 | 9.97 | 0.03 | 99.2 | 18 |
| HDPE | 0.33647 | 88 | 46 | 46 | 137 | 66/34 | 5.70 | 0.1 | 99.0 | 13 |
| PP | 0.33585 | 95 | 48 | 43 | 143 | 62/38 | | 0.5 | 99.6 | 3 |
| Real LLDPE | 0.33572 | 96 | 50 | 74 | 149 | 75/25 | 4.50 | <0.2 | 99.9 | 16 |
| Real LDPE | 0.33626 | 90 | 47 | 58 | 140 | 71/29 | 1.12 | 7.6 | 90.4 | 16 |
| SP-1 flake graphite | 0.33571 | 96 | 53 | 76 | 158 | 89/11 | 2.48 | ~0 | 99.4 | |
| MTI artificial graphite | 0.33604 | 93 | 41 | 39 | 122 | 81/19 | 2.48 | 0.53 | 99.2 | |
| MSE natural graphite | 0.33581 | 95 | 43 | 85 | 128 | 82/18 | 1.38 | <0.1 | 99.3 | |

^{a}Determined from the XRD analysis.
^{b}Obtained from the N₂ adsorption at −196° C.
^{c}Obtained from the TGA study under air at 800° C.
^{d}Obtained from EDS analysis.

Deconvolution of the XRD profile of the LLDPE graphite in the region of 2 theta=41° to 48°; areas under the peaks marked 2H (101) and 3R (101) were used to determine the relative % of 2H and 3R phases listed in Table 2.

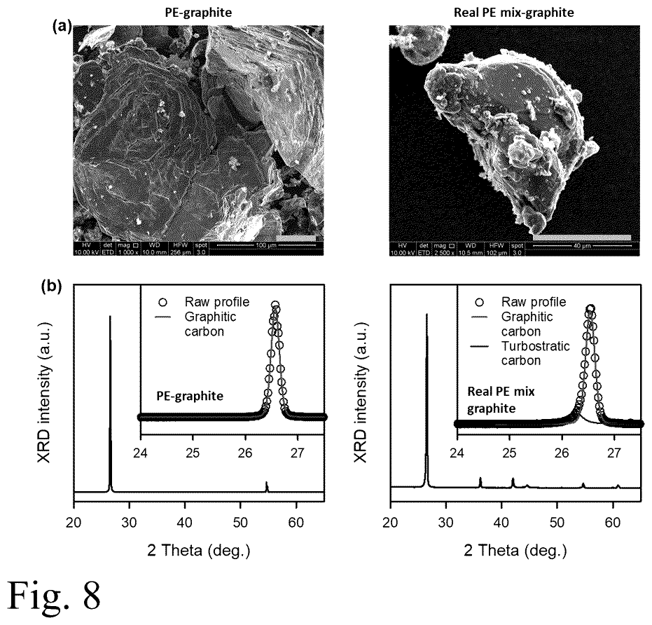

Metal oxide (such as Fe₂O₃) catalyst was also used for the catalytic graphitization of PE or real PE mix plastics (LLDPE:HDPE:LDPE=3:5:2) due to their low cost and recyclability after catalytic graphitization. In this process, the Fe₂O₃ particle was used for the stabilization or carbonization process of PE or real PE mix plastics and as a catalyst during the catalytic graphitization process. Fe₂O₃ particles were heated at 320° C. under air and added to the PE or real PE mix. The mixture was then heated to 1500° C., and held for 3 hours in Ar flow. As illustrated in FIG. 8a, the SEM images of PE or real PE mix-derived graphite displayed a highly crystalline “spherical” or “potato” graphite. This particular shape of graphite has been shown to be a very promising form of graphite for LIB anodes due to its low surface area, decreasing Coulombic losses, and high packing efficiency, therefore increasing volumetric and areal capacity (ACS Sustainable Chem. Eng. 2018, 6, 13199-13207). The XRD patterns (FIG. 8b) show a strong and sharp (002) peak at 2θ≈26.5°, indicating a high degree of carbon layer stacking along the c-axis to the graphene plane. Graphite characterization parameters (i.e., d₀₀₂, DG %, Lₐ, L_{c}) were calculated based on the XRD analysis and are summarized in Table 3. PE-derived graphite with Fe₂O₃ is of high purity (<4 m²/g surface area, <0.1 wt % ash, >99% carbon) and is available in particle sizes from a micrometer to a few-hundred-micrometer scale. When the Fe₂O₃ catalyst was added to a real PE mix, a relatively low DG % was obtained. This is probably due to the presence of inorganic colorants in real PE packing material, which is evidenced by high ash content measured in these feedstocks. As a result, essentially identical qualities were observed regardless of which catalyst (Fe or Fe₂O₃) and which plastic (PE or PP or real PE mix) were used.

TABLE 3
Physical properties of the PE or real PE mix-derived graphite synthesized with Fe₂O₃ catalyst

| | d₍₀₀₂₎ | DG | L_{c} | Lₐ | N_{c} | 2H/3R | S_{BET} | Ash | Fixed carbon | Graphite Yield |
|---|---|---|---|---|---|---|---|---|---|---|
| Carbon source | (nm)^{a} | (%)^{a} | (nm)^{a} | (nm)a | (—)^{a} | (%)^{a} | (m²/g)^{b} | (wt %)^{c} | (at %)^{d} | from PE (wt %) |
| LLDPE | 0.33574 | 99 | 61 | 98 | 182 | 86/14 | 3.92 | 0.08 | 99.2 | 4 |
| Real PE mix^{e} | 0.33629 | 90 | 49 | 57 | 146 | 60/40 | 0.43 | 16.7 | 82.5 | 3 |

^{a}Determined from the XRD analysis.
^{b}Obtained from the N2 adsorption at −196° C.
^{c}Obtained from the TGA study under air at 800° C.
^{d}Obtained from EDS analysis.
^{e}LLDPE:HDPE:LDPE = 3:5:2.

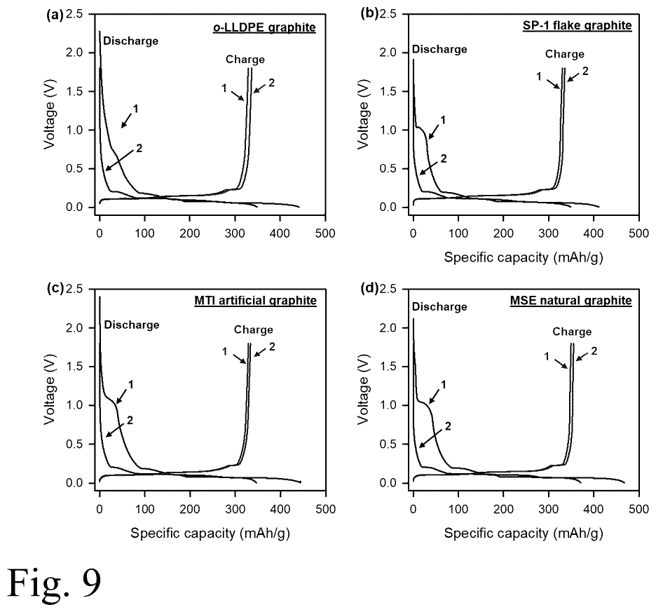

The PE-derived graphite powder was used to fabricate LIB anodes, and the electrochemical performance was compared with three commercial battery-grade graphite samples. It is expected that the high graphitization degree and low S_{BET} of o-LLDPE graphite would demonstrate better lithium-ion insertion and de-insertion performance. Coin-type half-cells were assembled with LiPF₆-based electrolyte and a mass loading of ˜2 mg/cm² with the o-LLDPE graphite. The initial Coulombic efficiency (ICE) and specific capacity, the most important parameters of graphite anode for evaluating the electrochemical performance of LIBs, were assessed. The first and second discharge and charge specific capacity and ICE at 0.1 discharge/charge cycles per hour (0.1 C) of o-LLDPE graphite and commercial graphite anodes are shown in Table 3, and the initial discharge/charge profiles are presented in FIG. 9. Discharge/charge profiles of o-LLDPE graphite anode at a rate of 0.1 C showed the first charge capacity of around 442 mAh/g with an ICE of 75%, which rapidly increased to 97% at the second discharge/charge cycle. The commercial graphite anodes delivered first discharge capacities of 411, 444, and 468 mAh/g with ICE of 80, 74, and 75%, respectively. The irreversible capacity is mainly caused by forming the well-known solid-electrolyte interphase (SEI) layer, the irreversible reaction between Li and surface functional groups, and other side reactions.³⁰ Although the ICE value of o-LLDPE graphite is lower than that of current-use battery graphite (>95%), it is comparable to that of commercial graphite anodes tested in this study.

TABLE 4
Initial discharge/charge specific capacity at 0.1 C and Coulombic
efficiency of commercial graphite and o-LLDPE graphite anodes

| | 1^{st} discharge | 1^{st} charge | ICE | 2^{nd} discharge | 2^{nd} charge | 2^{nd} (50^{th}) CE |
|---|---|---|---|---|---|---|
| Anode | (mAg/h) | (mAg/h) | (%) | (mAg/h) | (mAg/h) | (%) |
| o-LLDPE graphite | 442 | 330 | 75 | 349 | 337 | 97 (99.9) |
| SP-1 flake graphite | 411 | 330 | 80 | 349 | 336 | 96 (99.8) |
| MTI artificial graphite | 444 | 329 | 74 | 347 | 334 | 96 (99.9) |
| MSE natural graphite | 468 | 349 | 75 | 371 | 355 | 96 (99.9) |

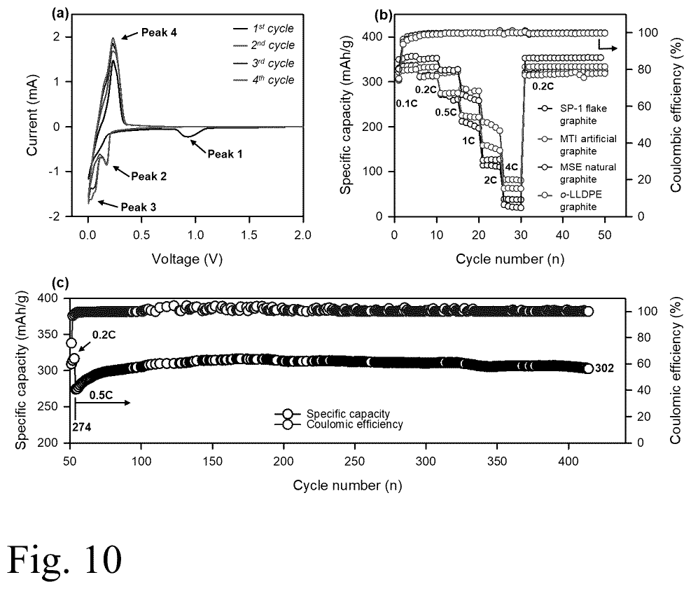

The cyclic voltammogram (CV) of the o-LLDPE graphite anode was investigated at 0.1 C within a voltage of 0.01 and 2 V (FIG. 10a). The first CV curve has a wide reduction peak (Peak 1) at around 0.93 V, which is attributed to the formation of the SEI layer during the first charge and discharge.³¹ This peak disappears after the first cycle, indicating that the SEI layer is mainly formed during the first cycle and remains stable. Two new peaks appear near 0.17 V (Peak 2) and ˜0 V (Peak 3) at the second CV curve. Peak 2 and peak 3 are related to the irreversible and reversible intercalation of lithium ions into the graphite sheet, respectively. The prominent oxidation peak (Peak 4) of approximately 0.23 V related to the deintercalation of lithium ions increases over the cycles, resulting in a greater charge capacity at the second cycle (337 mAg/h) than the first cycle (330 mAg/h). After the first cycle, the CV curves tend to overlap, indicating the stabilization of insertion and desertion of lithium ions in the o-LLDPE graphite anode. The rate capabilities were subsequently evaluated at the current rates from 0.1 to 4 C (FIG. 10b). The o-LLDPE graphite anode delivered reversible capacities of 325, 312, 275, 223, 154, and 62 mAh/g at 0.1, 0.2, 0.5, 1, 2, and 4 C, respectively. When the current rate was changed from 4 C to 0.2 C, a reversible capacity of 318 mAh/g was achieved, and the capacity retention rate was almost 100% after 50 cycles, indicating an excellent rate performance of o-LLDPE graphite anode.

The performance of o-LLDPE graphite anode was retested after three months to investigate the durability (FIG. 10c). o-LLDPE graphite anode was first subjected to three cycles at 0.2 C, and then subjected to 100 cycles at 0.5 C. It was found that the reversible specific capacity slightly increased from 309 to 316 mAh/g during the first three cycles at 0.2 C rate, and the capacity retention rate increased from 76 to 98%. A noticeable observation of the o-LLDPE graphite anode was that the charge capacity gradually increased from 274 mAh/g to 302 mAh/g after 415 cycles at 0.5 C, where the capacity retention rate remained almost 100%. The increase in specific capacity may be due to the improved accessibility of lithium ions in the carbon layers during cycling, increasing charge regulation behavior. As a result, the PE-derived highly crystalline flake graphite material performs remarkably as a LIB anode compared to commercial graphite anode materials. It is worth noting that o-LLDPE graphite was directly used without processing, such as milling, shaping, and/or surface treatment, suggesting further performance improvements can be achieved with these methods.

### EXPERIMENTAL METHODS

### A-1. Materials

Linear low-density polyethylene (LLDPE) with a melt index of 20 g/10 (measured at 190° C.) was purchased from Exxon Mobil; low-density polyethylene (LDPE), high-density polyethylene (HDPE), and polypropylene (PP) were purchased from Sigma-Aldrich. Bulk plastics were used as received without further processing, such as hot pressing to form a thin film. Reagent grade NaCl, KCl, HCl, and KOH were purchased from Sigma-Aldrich. Fe particles (10 microns) were purchased from Sigma-Aldrich. YP-50F was purchased from Kuraray. Deionized (DI) water was produced from a Barnstead EASYpure LF system (purity of 18.2 MOhm-cm). For comparison, three commercial battery-grade graphite were purchased from Ted Pella (SP-1, Natural Flake Graphite), MTI Corporation (EQ-Lib-CMSG, Artificial Graphite), and MSE supply (MSE PRO Natural Graphite, Natural Graphite).

Coal sample (DECS-8 from Penn State Coal bank) was charred at 900° C. in Ar for 1 hour and sieved for the desired particle size. All solid additives were sieved into 40-80 mesh (180-400 um). Since the solid additives have different densities, amounts with equal volumes were used in bulk oxidation. Real LLDPE (cling wrap) used by movers to secure pallets and real LDPE (shrink wrap) used for packaging water bottles onto cardboard trays were cut into small pieces. Commercial battery-grade MCMB synthetic graphite was purchased from MSE supplies.

### A-2. Thermal Oxidation of PE and PP Plastics

Bulk plastic feedstocks were thermally oxidized in a beaker (50 mL) in the absence or presence of the solid additives. An impeller blade was used to make contact with oxygen in the air. Generally, 20 g of the solid additive was heated to the target temperature, and 2 g of plastics were added. This mixture was manually stirred with a spatula for 10 minutes and then mixed with a two-blade impeller for mechanical mixing (80 rpm). After the air processing, the mixture was heated at 800° C. for 1 hr in Ar flow to produce carbon char, then cooled to room temperature. Finally, it was washed with warm DI water to remove the solid additives. The char yield of oxidized plastics was calculated after the carbonization process at 800° C. in Ar for 1 hour.

### A-3. Successive Additions of the PE

2 g of LLDPE and 20 g of NaCl were used for the first cycle, and 2 g of LLDPE was successively added into the mixture of o-LLDPE and NaCl after every 1 hour 5 times at 310° C. oxidized plastic (o-plastic) yield of 41.5 wt % was observed from successive addition of bulk LLDPE six cycles, similar to that obtained from one cycle (40 wt %), indicating repeatable air processing of the bulk plastic without adding NaCl. This result implies that the thin carbonaceous layer on the solid additive could also serve the same role as helping the oxidative environment in air processing. SEM image of the resulting product revealed that the charred LLDPE showed a similar morphology to that of the NaCl additive, supporting that a thin o-LLDPE layer on the solid additive was formed over the cycle.

### A-4. Material Characterization

XRD profiles of powder samples were collected using a Malvern Panalytical Empyrean X-ray diffractometer with Cu radiation (kα=0.154187 nm) operated at 45 kV and 40 mA. The sample was placed on a zero-background silicon holder (200 μm depth) and was scanned at the spinning stage with a step size of 0.013 degree. The scan time was 200 seconds/step, and the number of points was 5000. The instrument was calibrated with silicon as standard reference material for both peak locations and full width at half-maximum (FWHM). A state-of-the-art “parallel beam optic system” was utilized to eliminate instrumental contributions to the XRD profile, associated with a different penetration depth of X-ray which in turn causes shifting and broadening of lineshapes (Speakman, “Basic of X-ray Diffraction”, http://prism.mit.edu/xray/). This technique was applied to the position of (002) peak, ranging from 22° to 30°. The obtained XRD profile for (002) peak was fitted with the pseudo-Voigt function using OriginPro 2022, which is the linear combination of Lorentzian and Gaussian functions (eq. 1),

$$y = {y}^{0} + A [ {m}_{u} \frac{2}{π} \frac{ω}{4 {( x - {x}_{c} )}^{2} + {ω}^{2}} + ( 1 - {m}_{u} ) \frac{\sqrt{4 ln 2}}{ω \sqrt{π}} {exp}^{- 4 l n 2 \frac{{( x - {x}_{c} )}^{2}}{{ω}^{2}}} ] \qquad ( eq . 1 )$$

where, y⁰, x_{c}, ω, and A represent offset, center, width, and area, respectively. Mᵤ is the profile shape factor (0-1).

After deconvolution of the XRD profile, both peaks for graphitic and turbostratic carbons were weighted based on component areas (eq. 2).

$$\begin{matrix}{X}_{( g , t )} = \frac{{A}_{( g , t )}}{{\sum }_{i = 1}^{n} {A}_{i}} & {d}^{′} = {X}_{g} {d}_{g} + {X}_{t} {d}_{t}\end{matrix} \qquad ( eq . 2 )$$

Where X_{g} and Xₜ are represent constituents of fitted graphitic and turbostratic peaks; d_{g} and dₜ are represent d spacing of fitted graphitic and turbostratic peaks; A_{g} and Aₜ are represent the area of fitted graphitic and turbostratic peaks; and d′ is weighted d-spacing based on component areas. DG % of graphite samples quantified by Maire-Mering equation (eq. 3)

$$DG ( \% ) = \frac{0.34 \; 40 - {d}^{′}}{0.3440 - 0.3354} \times 100 \qquad ( eq . 3 )$$

Where, 0.3440 and 0.3354 are the d-spacings of the non-graphitized carbon (turbostratic carbon) and the ideal graphite crystal, respectively.
The apparent crystallite size was estimated from the width of the Bragg lines using the Scherrer equation (J. Appl. Cryst., 1968, 1, 257) (eq. 4).

$${L}_{c} = \frac{( 0.91 ) λ}{β cos θ} , {L}_{a} = \frac{( 1.84 ) λ}{β cos θ} \qquad ( eq . 4 )$$

Where L_{c} and Lₐ are the apparent crystallite size parallel and perpendicular, respectively, to the c-direction, λ is the wavelength, and β is the instrument-corrected FWHM of an appropriate Bragg line on the usual 2θ scans: the (002) and (101) lines for determining L_{c} and Lₐ, respectively. The number of layers (N_{c}) along the c-axis was estimated by N_{c}=L_{c}/d₍₀₀₂₎.

Raman spectroscopy was also carried out on a Horiba LabRam HR Evolution spectrometer. Spectra were recorded at room temperature using a 532 nm laser excitation source and frequency calibrated with a silicon wafer (520.52 cm⁻¹). Thermal gravimetric analysis (TGA) was performed on a Mettler Toledo TGA/DSC 3+ Star system. The sample was placed into an alumina crucible (75 L) and heated under N₂ or air flow (75 mL/min) at a rate of 5° C. Scanning electron microscopy (SEM) analysis was conducted with an FEI Quanta 600 using secondary electron and backscattered electron detectors with an accelerating voltage of 10 kV. The FEI Quanta 600 is coupled with an energy-dispersive X-ray detector to obtain elemental analysis. The BET surface area was measured at −196° C. using a volumetric gas sorption analyzer (Autosorb IQ, Quantachrome). Before measurement, the sample (˜800 mg) was degassed in a vacuum at 300° C. for 1 hour.

### A-5. Graphite Synthesis from Oxidized Plastic for LIB Application

Carbonized PE or PP or mixed PE plastics was mixed with metallic Fe (or Fe2O3) particles, where Fe/plastic=1:1 mass ratio were used. The mixed particles were then ball-milled at 600 rpm for 15 minutes (Planetary Ball Mills Pulverisette 7, Fritsch), and pelletized with pressing dies (MTI Corporation) under pressure with 5 ton/cm² for intimate contact between Fe and carbonized plastics. Next, the pellet was placed in a graphite boat, heated to 1500° C. with a ramping rate of 5° C./min, held for 3 hours in Ar (or N₂) flow, and cooled down to room temperature with a ramping rate of 5° C./min. After cooling down, the sample was immersed in a 2M-HCl solution at 80° C. twice for 3 hours to remove the residual Fe catalyst, then washed with DI water three times. The resulting product was dried and used directly for the characterization. The graphite yield was 13-18 wt %, calculated from pristine plastics.

### A-6. Lithium-Ion Battery Fabrication and Performance Testing

Electrochemical studies were performed by first preparing CR2032 coin cells. The coin half-cells were assembled in an argon-filled glove box (<0.1 ppm O₂, using carbon as the working electrode and metallic lithium foil as the counter electrode. The coins each consist of a bottom can, lithium metal as the counter electrode, separator, disk electrode, stainless steel disk spacer, wave spring, and top can. These components were sequentially placed in the bottom can. The electrolyte was added to the separator before the disk electrode was stacked. The anode was prepared by casting a slurry containing 95 wt % ground graphite material, and 5 wt % polyvinylidene difluoride (PVDF) binder in n-methyl-2-pyrrolidone (NMP) solvent onto a copper foil. The standard electrolyte for LIBs consisted of a solution of 1.0 M LiPF6 in ethylene carbonate (EC)-dimethyl carbonate (DMC)-diethyl carbonate (DEC) (1:1:1 by volume) with 5% of fluoroethylene carbonate (FEC). After the top can was dropped onto the stack, the assembly was transferred to the coin cell crimper and crimped together. Galvanostatic charge/discharge cycling between 0 and 1.8 V was performed at room temperature under different rates using an Arbin potentiostat/galvanostat multichannel system.

### Additional Examples and Discussion of Material in Capacitors

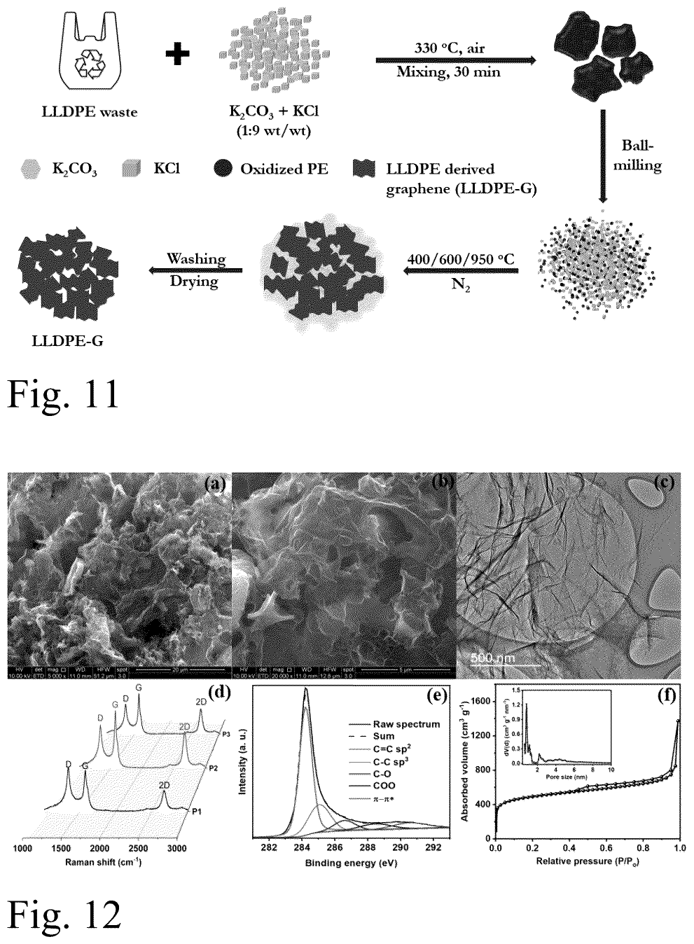

The upcycling LLDPE waste into graphene synthesis procedure is schematically illustrated in FIG. 11. A mixture of potassium carbonate (K₂CO₃) and KCl with ratio of 1:9 (wt/wt) was mixed with LLDPE waste (shopping bag, ratio of LLDPE to mixture salts of 1:10 wt/wt) heated at 330° C. for 30 minutes in air in pre-treatment oxidation step to stabilize LLDPE for following carbonization and graphenization steps. The K₂CO₃ was used not only as surface area enhancer additive in assisting of KCl but also as catalyst for graphenization in subsequent step. After pre-treatment step, a mixture of oxidized LLDPE, K₂CO₃ and KCl was ball-milled for 15 minutes to homogeneous powder, following by thermal treatment in inert nitrogen atmosphere at 400, 600 and 950° C. for 1 hour at each temperature for further aromatization, carbonization and graphenization, respectively. After washing, filtering, and drying, the obtained product was LLDPE derived graphene, denoted as LLDPE-G, with the production yield of ˜7-8 wt. %. The filtrate collected after filtering step was neutralized with potassium bicarbonate (KHCO₃) and then dried to recover mixture of K₂CO₃ and KCl for subsequent recycling. The washed product can be further cleaned by an additional wash with aqueous acid (e.g., 2M HCl) to remove mineral contaminate from the waste plastic.

FIG. 12 shows the characteristic properties of LLDPE-G. The SEM images of LLDPE-G reveal crumpled and wrinkled nanosheet structure. The TEM image further confirms thin and wrinkled nanosheet structure with multi-micron size. The Raman spectra taken at three different positions shown in FIG. 2d exhibit three typical bands around 1344, 1575 and 2675 cm⁻¹, which can be assigned to the D, G and 2D band of carbon materials, respectively. The D band is associated to the structural defects or partially disordered structures of graphitic domains while the G band is attributed to the graphitic domains of carbon materials and 2D band is second order of D band. The prominent of 2D peak and average I_{D}/I_{G} ratio of 0.85 indicate the excellent graphitic degree of LLDPE-G. The deconvoluted XPS C1s spectra of LLDPE-G in FIG. 2e further confirms the graphitic degree with ˜60% of conjugated sp² carbon component. The nitrogen adsorption-desorption isotherms in FIG. 2f displays combined characteristics of type I(b) and type IV(a) curves with hysteresis loop occurring at relative pressures of 0.45 to 0.95, and a vertical tail at the relative pressure of 0.95 to 0.995, indicating the hierarchical micro/meso/macro pores structures. The total pore volume estimated at relative pressure of 0.995 was as high as 1.16 cm³/g, confirming highly porous structure of LLDPE-G. The specific surface areas (SSA) calculated by Brunauer-Emmett-Teller (BET) method was as high as 1800 m²/g. In summary, LLDPE-G possesses graphitic nanosheet structure with high BET surface area and hierarchical pore size distribution, which are highly desired for supercapacitor electrode materials.

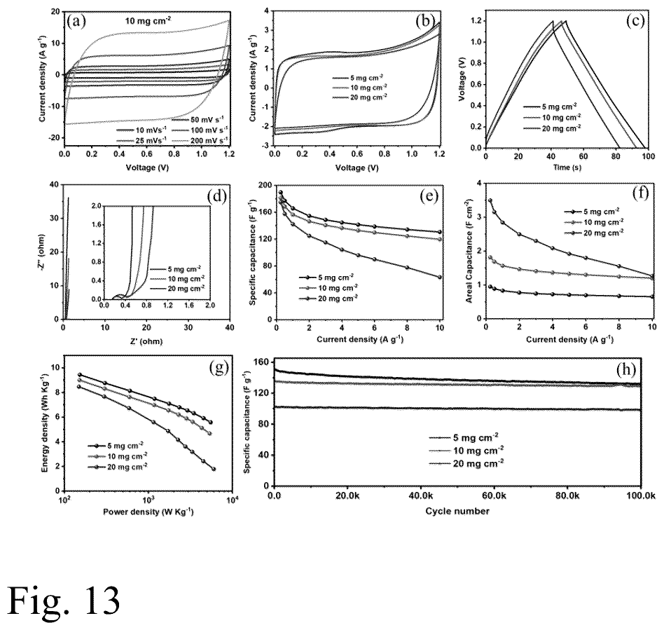

We demonstrated LLDPE-G as excellent electrode material for high performance supercapacitor, in comparison with commercial state-of-the-art (SOTA) Kuraray YP-50F. FIG. 13 shows the electrochemical capacitive properties of LLDPE-G supercapacitor with mass loading of 5.0, 10.0 and 20.0 mg/cm² using 1M H₂SO₄ electrolyte. The cyclic voltametric (CV) curves of supercapacitor with mass loading of 10.0 mg cm⁻² in FIG. 13a exhibit a quasi-rectangular shape, even at very high scan rate of 200 mV s⁻¹, indicating nearly ideal electrical-double-layer capacitive behavior. There is not much difference in the shape of CV curves (FIG. 13b) and galvanostatic charge-discharge curves (GCD, FIG. 13c) when mass loading increases from 5.0 to and 20.0 mg cm⁻², twice of commercial level mass loading, implying excellent performance of LLDPE-G not only at low mass loading but also at high mass loading. The electrochemical impedance spectroscopy in FIG. 13d reveals the equivalent series resistance (ESR) of LLDPE-G supercapacitors are very small, less than 0.8Ω, thanks to high electrical conductivity due to high graphitic degree and hierarchical micro/meso/macro pore size distribution. The gravimetric specific capacitances of LLDPE-G were 190, 181 and 175 F g⁻¹ at current density of 0.25 A g⁻¹ for supercapacitor with mass loading of 5.0, 10.0 and 20 mg cm⁻², respectively (FIG. 13e). Correspondingly, the energy densities of LLDPE-G were 9.4, 9.0 and 8.5 Wh kg⁻¹ (FIG. 13g). Furthermore, the LLDPE-G exhibits outstanding cycling stability with specific capacitance retention of ˜87 to ˜95% after 100,000 cycles at current density of 4.0 A g⁻¹ (FIG. 13h).

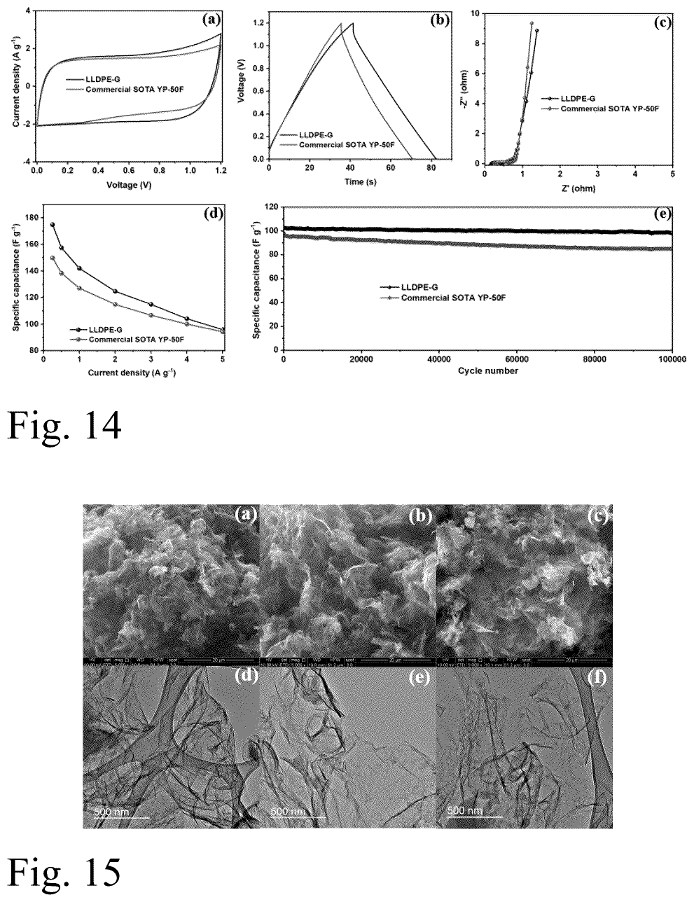

To quantify the excellent electrochemical capacitive performance of LLDPE-G, LLDPE-G and commercial SOTA YP-50F were tested at the same condition at mass loading of 20 mg cm-2. The electrochemical capacitive properties of LLDPE-G in comparison with SOTA YP-50F were shown in FIG. 14 and Table 5. As shown in Table 5, the specific capacitance of LLDPE-G at current density of 0.25 A g-1 was 175 F g⁻¹, which is about 17% higher than YP-50F. More impressively, the energy density of LLDPE-G reaches 7.86 Wh kg⁻¹, outperforms 6.27 Wh kg⁻¹ of YP-50F. Finally, LLDPE-G exhibit outstanding cycling stability with capacitance retention of 95.8%, in comparison to 88.5% of YP-50F, after 100,000 cycles at current density of 4.0 A g⁻¹. These excellent capacitive properties of LLDPE-G indicate great potential for practical supercapacitor application.

TABLE 5
BET surface area and electrochemical capacitive
properties of LLDPE-G and YP-50F.

| | BET | Specific | | Capacity retention |
|---|---|---|---|---|
| | surface | capacity at | Energy | after 100,000 cycles |
| | area | 0.25 A/g | density | at current density |
| | (m² g⁻¹) | (F g⁻¹) | (Wh kg⁻¹) | of 4.0 A/g (%) |
| LLDPE-G | 1800 | 175 | 7.86 | 95.8 |
| Commercial | 1760 | 150 | 6.27 | 88.5 |
| SOTA | | | | |
| YP-50F | | | | |

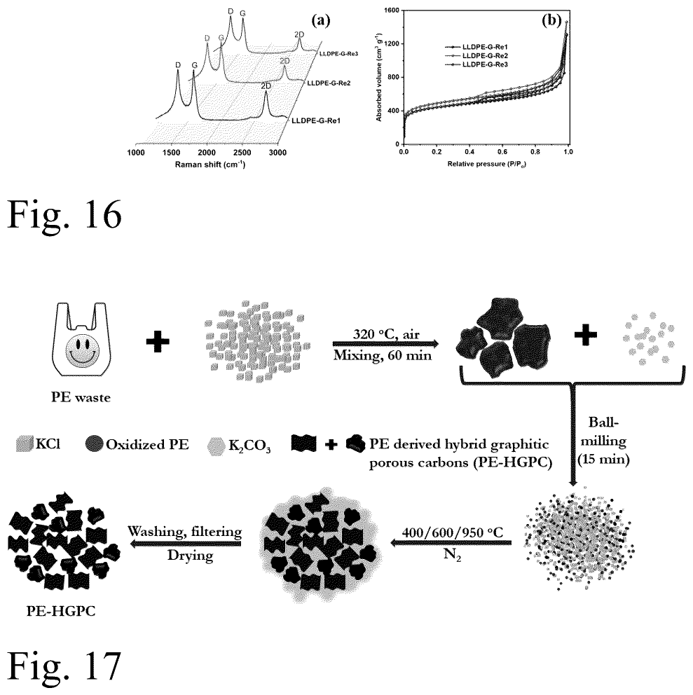

The mixture of K₂CO₃ and KCl was recovered for subsequent recycling for three times and the obtained graphenes were denoted as LLDPE-G-Rex where x is the recycle time. FIG. 15 shows SEM images and TEM images of LLDPE-G-Rex displaying thin crumpled and wrinkled nanosheet structure, similar to LLDPE-G. Raman spectra of LLDPE-G-Rex in FIG. 16a also exhibit three prominent D, G and 2D band with I_{D}/I_{G} of ˜1.0, which is akin to LLDPE-G. Moreover, nitrogen isotherms of LLDPE-G-Rex in FIG. 16b also display combined characteristics of type I(b) and type IV(a) curves with hysteresis loop occurring at relative pressures of 0.45 to 0.95, and a vertical tail at the relative pressure of 0.95 to 0.995, indicating the hierarchical micro/meso/macro pores structures. The BET surface area of LLDPE-G-Re1, LLDPE-G-Re2, and LLDPE-G-Re3 were 1622, 1792 and 1615 m² g⁻¹ whereas the total pore volume of LLDPE-G-Re1, LLDPE-G-Re2, and LLDPE-G-Re3 were 1.14, 1.31 and 1.27 cm³ g⁻¹, respectively, which are also comparable to LLDPE-G. The similarity in morphology and properties of LLDPE-G-Rex and LLDPE-G shows that we are successful in recycling K₂CO₃ and KCl, creating an opportunity for low-cost and sustainable upcycling LLDPE waste into high quality graphene.

Upcycling PE into Hybrid Graphitic Porous Carbons for High Performance Zinc-Ion Hybrid Capacitor Application

We developed a facile process to upcycle LLDPE waste into graphene by using a mixture of K₂CO₃ and KCl as surface area enhancer additive in pre-treatment oxidation step. However, the presence of K₂CO₃ would lead to the formation of carbonate anion radical (via reaction OH·+CO₃²⁻→CO₃·⁻+OH⁻), which is weak oxidizing agent (ref: Acc. Chem. Res., 2020, 53, 2189-2200), leading to incomplete oxidation in the pre-treatment step, resulting in limited graphene yield of 7-8 wt. %. We tested mixed PE wastes including high density polyethylene (HDPE), low density polyethylene (LDPE) and LLDPE with ratio of 5:2:3, which simulates the ratio of real-world PE wastes. The upcycling mixed PE wastes into hybrid graphitic porous carbon synthesis procedure is schematically illustrated in FIG. 17. The KCl was mixed with mixed PE wastes (shopping bags and wraps, ratio of mixed PE wastes to KCl of 1:10 wt/wt) heated at 320° C. for 60 minutes in air in pre-treatment oxidation step to stabilize mixed PEs for following carbonization and graphenization steps. After pre-treatment step, a mixture of oxidized PE and KCl was mixed with 1 part of K₂CO₃ and ball-milled for 15 minutes to form a homogeneous powder, followed by thermal treatment in inert nitrogen atmosphere at 400, 600 and 950° C. for 1 hour at each temperature for further aromatization, carbonization and graphenization, respectively. After washing, filtering, and drying, the obtained product was hybrid graphitic porous carbon, denoted as PE-HGPC, with the production yield of ˜20-22 wt. %. The filtrate collected after filtering step was neutralized with hydrochloric acid (HCl) until pH ˜2 and then dried to recover KCl for subsequent recycling.

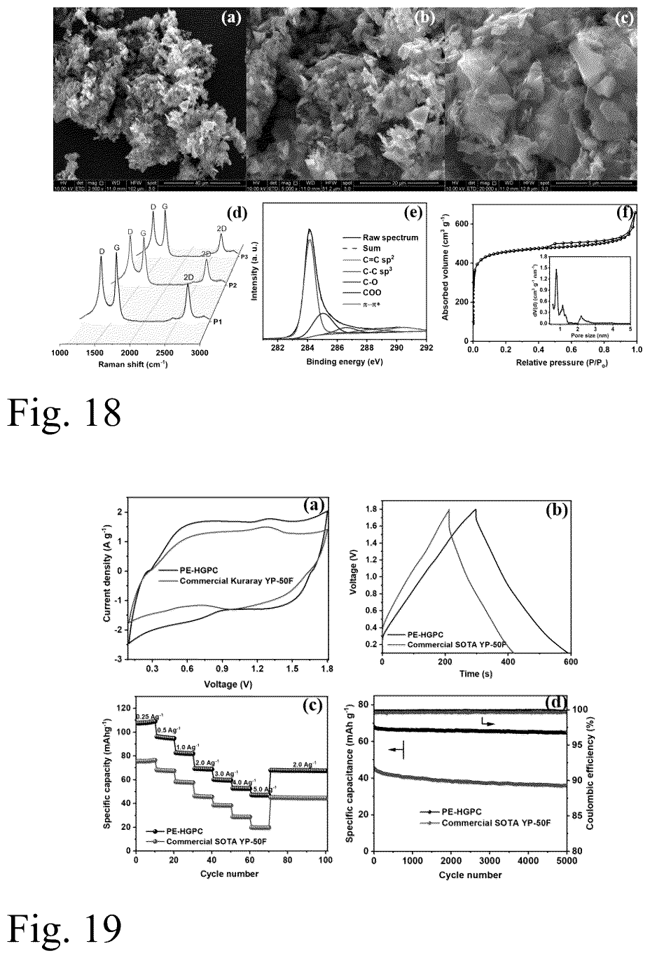

FIG. 18 shows the characteristic properties of PE-HGPC. The SEM images of PE-HGPC display mixture of thin, wrinkled carbon nanosheets and micron-sized carbon particles. The close-up SEM image in FIG. 18c reveals carbon nanosheets grown from surface of carbon particles, creating hybrid structure. The Raman spectra taken at three different positions shown in FIG. 18d exhibit three typical bands around 1344, 1575 and 2675 cm¹, which can be assigned to the D, G and 2D band of carbon materials, respectively. The D band is associated to the structural defects or partially disordered structures of graphitic domains while the G band is attributed to the graphitic domains of carbon materials and 2D band is second order of D band. The prominent of 2D peak and average I_{D}/I_{G} ratio of ˜1.0 indicate the excellent graphitic degree of PE-HGPC. The deconvoluted XPS CIs spectra of PE-HGPC in FIG. 18e further confirms the graphitic degree with ˜62% of conjugated sp² carbon component. The nitrogen adsorption-desorption isotherms in FIG. 18f displays combined characteristics of type I(b) and type IV(a) curves with hysteresis loop occurring at relative pressures of 0.45 to 0.95, and a vertical tail at the relative pressure of 0.95 to 0.995, indicating the hierarchical micro/meso/macro pores structures. The QSDFT pore size distribution in the inset of FIG. 18 confirms the micropores are ranging from 0.5 to 1.5 nm whereas the mesopores are mainly from 2.0 to 3.0 nm. The total pore volume determined at relative pressure of 0.995 was 0.85 cm³/g, confirming porous structure of PE-HGPC. The SSA calculated by BET method was as high as 1763 m²/g. In summary, PE-HGPC possesses hybrid structure of graphitic carbon nanosheets and particles with high BET surface area and hierarchical pore size distribution, which are highly desired for electrochemical electrode materials.

PE-HGPC was used as cathode material for high performance zinc-ion hybrid capacitor (ZIHC), emerging electrochemical energy storage technology, in comparison with commercial SOTA Kuraray YP-50F. The electrochemical capacitive properties of PE-HGPC and YP-50F ZIHCs with mass loading of 10.0 mg cm⁻² and 2M ZnSO₄ electrolyte were shown in FIG. 19 and Table 6. The CV curves of PE-HGPE and YP-50F were quasi-rectangular with reversible redox humps, confirmed that the charge/discharge mechanism of ZIHC is a combination of batteries and supercapacitors. Notably, the CV area of PE-HGPC significantly larger than YP-50F, suggesting larger specific capacitance (FIG. 19a). The GCD curves in FIG. 19b were almost symmetric in shapes with small IR drops, suggesting excellent electrochemical reversibility. Remarkably, IR drop of PE-HGPC is only 0.097 V, much smaller than 0.21 V of YP-50F, suggesting much lower ESR, thanks to high electrical conductivity due to high graphitic degree and hierarchical micro/meso/macro pore size distribution of PE-HGPC. Consequently, PE-HGPC has much higher specific capacitance, up to 109.1 mAhg⁻¹ at current density of 0.25 Ag⁻¹, which is about 43% higher than YP-50F. Similarly, the energy density of PE-HGPC reaches 79.5 Wh kg⁻¹, outperforms 59.6 Wh kg⁻¹ of YP-50F. Moreover, PE-HG exhibit excellent cycling stability with capacitance retention of 95.4%, in comparison to 78.9% of YP-50F, after 5,000 cycles at current density of 2.0 A g⁻¹. These excellent capacitive properties of PE-HGPC possesses great potential for practical ZIHCs application.

TABLE 6
BET surface area and electrochemical capacitive properties
of PE-HGPC and YP-50F as cathod materials for ZIHC.

| | BET | Specific | | Capacity retention |
|---|---|---|---|---|
| | surface | capacity at | Energy | after 5,000cycles |
| | area | 0.25 A g⁻¹ | density | at current density |
| | (m² g⁻¹) | (mAh g⁻¹) | (Wh kg⁻¹) | of 2.0 A g⁻¹ (%) |
| PE-HGPC | 1763 | 109.1 | 79.5 | 95.4 |
| Commercial | 1760 | 76.4 | 59.6 | 78.9 |
| SOTA YP-50F | | | | |

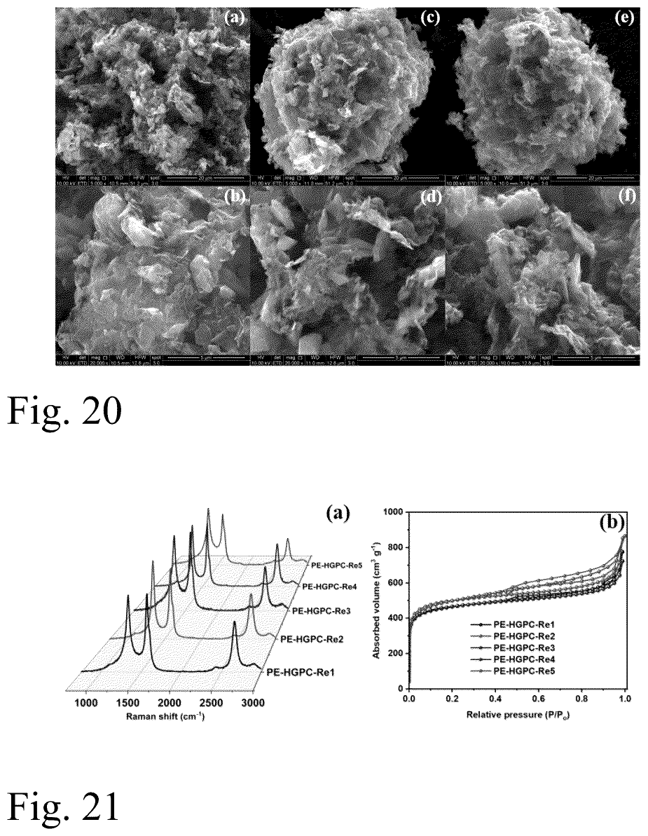

As mentioned above, we recovered KCl for subsequent recycling for at least 5 times and the obtained products were denoted as PE-HGPC-Rex where x is the recycle time. FIG. 20 shows SEM images of LLDPE-G-Rex showing hybrid structure of carbon nanosheets and particles, similar like PE-HGPC. Raman spectra of PE-HGPC-Rex in FIG. 21a also exhibit three prominent D, G and 2D band with I_{D}/I_{G} of ˜1.0, which is analogous to PE-HGPC. Moreover, nitrogen isotherms of LLDPE-G-Rex in FIG. 21b also display similar characteristics with the combination of type I(b) and type IV(a) curves with hysteresis loop occurring at relative pressures of 0.45 to 0.95, and a vertical tail at the relative pressure of 0.95 to 0.995. Interestingly, BET surface area and total pore volume of PE-HGPC-Rex are slightly higher than PE-HGPC (Table 7). The similarity in morphology and properties of PE-HGPC-Rex and PE-HGPC indicates that we were successful in recycling KCl, creating an opportunity for low-cost and sustainable upcycling PE wastes into hybrid graphitic porous carbons.

TABLE 7
BET surface area and total pore volume of PE-HGPC-Rex

| | BET surface area | Total pore volume |
|---|---|---|
| | (m² g⁻¹) | (cm³ g⁻¹) |
| PE-HGPC-Re1 | 1762 | 0.96 |
| PE-HGPC-Re2 | 1903 | 1.02 |
| PE-HGPC-Re3 | 1779 | 0.93 |
| PE-HGPC-Re4 | 1777 | 0.95 |
| PE-HGPC-Re5 | 1955 | 1.15 |

### REFERENCES

1. Liu, W.-J.; Jiang, H.; Yu, H.-Q. Emerging applications of biochar-based materials for energy storage and conversion. Energy Environ. Sci. 2019, 12, 1751-1779.
2. Sagues, W. J.; Yang, J.; Monroe, N.; Han, S.-D.; Vinzant, T.; Yung, M.; Jameel, H.; Nimlos, M.; Park, S. A simple method for producing bio-based anode materials for lithium-ion batteries. Green. Chem. 2020, 22, 7093-7108.
3. Wen, F.; He, X.; Sun, S.; Jian, W.; Dai, R.; Meng, Q.; Lu, K.; Qiu, X.; Zhang, W. Production of polypropylene-derived novel porous carbon nanosheets through aromatization stabilization toward supercapacitor applications. Chem. Eng. Sci. 2023, 270, 118559.
4. Vieira, O.; Ribeiro, R. S.; Diaz de Tuesta, J. L.; Gomes, H. T.; Silva, A. M. T. A systematic literature review on the conversion of plastic wastes into valuable 2D graphene-based materials. Chem. Eng. J. 2022, 428, 131399.
5. Pandey, S.; Karakoti, M.; Dhali, S.; Karki, N.; SanthiBhushan, B.; Tewari, C.; Rana, S.; Srivastava, A.; Melkani, A. B.; Sahoo, N. G. Bulk synthesis of graphene nanosheets from plastic waste: An invincible method of solid waste management for better tomorrow. Waste Management 2019, 88, 48-55.
6. Wang, J.; Shen, B.; Lan, M.; Kang, D.; Wu, C. Carbon nanotubes (CNTs) production from catalytic pyrolysis of waste plastics. The influence of catalyst and reaction pressure. Catal. Today 2020, 351, 50-57.
7. Acomb, J. C.; Wu, C.; Williams, P. T. Control of steam input to the pyrolysis-gasification of waste plastics for improved production of hydrogen or carbon nanotubes. Appl. Catal. B 2014, 147, 571-584. Liu et al. (Polymer Degradation and Stability, 2011, 96, 1711-1719) pyrolyzed polypropylene with the mixture of H-ZSM5 and NiO catalyst through a two-stage process. Lie et al. (Nature Catalysis, 2020, 3, 902-912) demonstrated the microwave-assisted catalytic deconstruction of various plastics with FeAlOx catalyst.
8. Parra, J. B.; Ania, C. O.; Arenillas, A.; Rubiera, F.; Palacios, J. M.; Pis, J. J. Textural development and hydrogen adsorption of carbon materials from PET waste. J. Alloys Compod. 2004, 379, 280-289.
9. Yaqoob, L.; Noor, T.; Iqbal, N. Conversion of plastic waste to carbon-based compounds and application in energy storage devices. ACS Omega 2022, 7, 13403-13435.
10. Yang, I.; Mok, J. H.; Jung, M.; Yoo, J.; Kim, M.-S.; Choi, D.; Jung, J. C. Polyethylene-derived activated carbon materials for commercially available supercapacitor in an organic electrolyte system. Macromol. Rapid Commun. 2022, 43, 2200006.
11. Zhang, B.; Song, C.; Liu, C.; Min, J.; Azadmanjiri, J.; Ni, Y.; Niu, R.; Gong, J.; Zhao, Q.; Tang, T. Molten salts promoting the “controlled carbonization” of waste polyesters into hierarchically porous carbon for high-performance solar steam evaporation. J. Mater. Chem. A 2019, 7, 22912-22923.
12. Weldekidan, H.; Mohanty, A. K.; Misra, M. Upcycling of plastic wastes and biomass for sustainable graphitic carbon production: A critical review. ACS Environ. Au 2022, 2, 510-522.
13. Choi, J.; Yang, I.; Kim, S.-S.; Cho, S. Y.; Lee, S.; Upcycling plastic waste into high value-added carbonaceous materials. Macromol. Rapid Commun. 2022, 43, 2100467.
14. Chen, S.; Liu, Z.; Jiang, S.; Hou, H. Carbonization: A feasible route for reutilization of plastic wastes. Sci. Total Environ. 2020, 710, 136250.
15. Ko, S.; Kwon, Y. J.; Lee, J. U.; Jeon, Y.-P. Preparation of synthetic graphite from waste PET plastic. J. Ind. Eng. Chem. 2020, 83, 449-458.
16. Choi, D.; Jang, D.; Joh, H-I.; Reichmanis, E.; Lee, S. High performance graphitic carbon from waste polyethylene: Thermal oxidation as a stabilization pathway revisited. Chem. Mater. 2017, 29, 9518-9527.
17. Speakman, S. A. Basics of X-ray powder diffraction. http://prism.mit.edu/xray/education.downloads.html (assessed: September 2022).
18. Seehra, M. S.; Pavlovic, A. S. X-Ray diffraction, thermal expansion, electrical conductivity, and optical microscopy studies of coal-based graphites. Carbon 1993, 31, 557-564.
19. Xie, B.; Hong, L.; Chen, P. Zhu, B. Effect of sulfonation with concentrated sulfuric acid on the composition and carbonizability of LLDPE fibers. Polym. Bull. 2016, 73, 891-908.
20. Kim, J. W.; Lee, J. S. Preparation of carbon fibers from linear low density polyethylene. Carbon 2015, 94, 524-530.
21. De Palmenaer, A.; Wortberg, G.; Drissen, F.; Seide, G.; Gries, T. Production of polyethylene based carbon fibres. Chem. Eng. Trans. 2015, 43, 1699-1704.
22. Younker, J. M.; Saito, T.; Hunt, M. A.; Naskar, A. K.; Beste, A. Pyrolysis pathways of sulfonated polyethylene, an alternative carbon fiber precursor. J. Am. Chem. Soc. 2013, 135, 6130-6141.
23. Hunt, M. A.; Saito, T.; Brown, R. H.; Kumbhar, A. S.; Naskar, A. K. Patterned functional carbon fibers from polyethylene. Adv. Mater. 2012, 24, 2386-2389.
24. Kim, P. J.; Fontecha, H. D.; Kim, K.; Pol, V. G. Toward high-performance lithium-sulfur batteries: Upcycling of LDPE plastic into sulfonated carbon scaffold via microwave-promoted sulfonation. Pol. ACS Appl. Mater. Interfaces 2018, 10, 14827-14834.
25. Li, C.; Zhu, H.; Salim, N. V.; Fox, B. L.; Hameed, N. Preparation of microporous carbon materials via in-depth sulfonation and stabilization of polyethylene. Polym. Degrad. Stab. 2016, 134, 272-283.
26. Villagómez-Salas, S.; Manikandan, P.; Acuña-Guzmán, S. F.; Pol, V. G. Amorphous carbon chips Li-ion battery anodes produced through polyethylene waste upcycling. ACS Omega 2018, 3, 17520-17527.
27. Choi, D.; Yeo, J.-S.; Joh, H-I.; Lee, S. Carbon nanosheet from polyethylene thin film as a transparent conducting film: “Upcycling” of waste to organic photovoltaics application. ACS Sustainable Chem. Eng. 2018, 6, 12463-12470.
28. Seehra, M. S.; Geddam, U. K.; Schwegler-Berry, D.; Stefaniak, A. B. Detection and quantification of 2H and 3R phases in commercial graphene-based materials. Carbon 2015, 95, 818-823.
29. Banek, N. A.; Abele, D. T.; McKenzie Jr., K. R.; Wagner, M. J. Sustainable conversion of lignocellulose to high-purity, highly crystalline flake potato graphite. ACS Sustainable Chem. Eng. 2018, 6, 13199-13207.
30. Hou, H.; Banks, C. E.; Jing, M.; Zhang, Y.; Ji, X. Carbon quantum dots and their derivative 3D porous carbon frameworks for sodium-ion batteries with ultralong cycle life. Adv. Mater. 2015, 27, 7861-7866.
31. Zhu, Z.; Zuo, H.; Li, S.; Tu, J.; Guan, W.; Song, W.-L.; Zhao, J; Tian, D.; Jiao, S. A green electrochemical transformation of inferior coals to crystalline graphite for stable Li-ion storage. J. Mater. Chem. A 2019, 7, 7533-7540.
32. Rong, T.; Yuan, Y.; Yu, H.; Zuo, H.; Xue, Q. Research on anthracite-derived graphite flakes prepared by molten salt electrolysis as anode materials for high-performance lithium-ion batteries. Fuel Process. Technol. 2023, 252, 107992.

1. A process of transforming waste plastic, comprising:
providing waste plastic comprising PE and PP;
adding a solid particulate additive; and combining the waste plastic with the solid additive; and
heating the waste plastic to a temperature of at least 300° C. to form a molten mixture with the solid additive and mixing the molten mixture with the solid additive while exposing the molten mixture to gaseous oxygen; wherein the solid additive remains as a solid during the step of exposing the molten mixture to gaseous oxygen.

2. The process of claim 1 wherein, following the step of exposing to oxygen, heating to at least 500° C. or at least 800° C. or heating to a temperature in the range of 500 to 1500° C. or 800 to 1500° C.

3. The process of claim 1 wherein the solid particulate additive comprises salts, chars, catalytically-active agents, metal oxides, and/or inert solid in the air processing.

4. The process of claim 1 wherein the solid additives are water soluble and removed from the composition by washing with water.

5. The process of claim 1 wherein the waste plastic contains, or is pre-treated to contain, at least 90 wt % or at least 95 wt % or at least 98 wt % of PE or PP or a combination of PE and PP.

6. The process of claim 1 comprising creating core-shell type functional materials that are coated with a carbon shell made from PE or PP.

7. The process of claim 6 comprising forming nickel particles coated with graphite, carbon nanotubes coated with graphite, or carbon nanotubes coated with porous carbons.

8. The process of claim 1 wherein the graphite is formed at a temperature of 1500 C or less for a period of 10 hours or less, or 7 hours or less, or 5 hours or less, or in the range of 1 to 10 hours.

9. The process of claim 1 wherein the solid particulate additive comprises zeolites or metal-organic frameworks, to improve their electrical/thermal conductivity.

10. The process of claim 6 wherein the core-shell particles comprise plasmonic nanoparticles coated by graphite.

11. The process of claim 1 wherein the solid particulate additive comprises solid particles that can graft with carbon materials.

12. The process of claim 1 wherein the solid particulate additive comprises metal or alloy particles resulting in a composite layer.

13-15. (canceled)

16. The process of claim 1 wherein the waste plastic comprises blended carbon feedstock comprises plastics mixed with biomass, coals, or carbonaceous materials.

17. The process of claim 1 wherein the solid additive comprises metals, metal oxides, or soluble metal salts or combinations thereof.

18. The process of claim 1 further comprising forming a lithium ion battery anode from the graphite.

19. A thermally stabilized carbon char or graphite made by the method of claim 1.

20-25. (canceled)

26. A process of transforming waste plastic, comprising:
providing waste plastic;
adding a solid particulate additive;
combining the waste plastic with the solid additive;
heating the waste plastic to a first temperature of at least 300° C. to form a molten mixture with the solid additive and mixing the molten mixture with the solid additive while exposing the molten mixture to gaseous oxygen; wherein the solid additive remains as a solid during the step of exposing the molten mixture to gaseous oxygen to produce an oxygen-treated product; and
after an optional comminution step;
heating the oxygen-treated product in vacuo or an inert atmosphere at a second temperature of at least 600° C.;
removing the solid additive; and
recovering a porous carbon material.

27-44. (canceled)

45. A porous carbon material that is characterizable by one or any combination of the following: a BET surface area of at least 1700 m²/g or at least 1800 m²/g or in the range of 1780 m²/g to 1820 m²/g; a total pore volume 0.8 to 1.2 cm³/g or at least 0.9 cm³/g as determined by QSDFT micropores in the bimodal pore distribution in the range of 0.5 to 1.5 nm and 2.0 to 3.0 nm.

46. The porous carbon material of claim 45 comprising graphene layers (Nc) between 137 and 155 and/or high 2H/3R ratio (>60/40) and/or graphene layers (Nc) greater than 20, and/or high 2H/3R ratio (>60/40), and/or high purity (>99.5% carbon).

47. A method of storing energy, comprising applying a voltage to a capacitor, supercapacitor or battery comprising the porous carbon material of claim 45.

48-50. (canceled)
